(19) United States
(12) Patent Application Publication
(10) Pub. No.: US 2023/0258526 A1
(43) Pub. Date: Aug. 17, 2023

(54) ACOUSTIC DIAGNOSTIC APPARATUS, ACOUSTIC DIAGNOSTIC METHOD, AND NON-TRANSITORY COMPUTER-READABLE STORAGE MEDIUM RECORDING ACOUSTIC DIAGNOSTIC PROGRAM

(71) Applicant: KABUSHIKI KAISHA TOSHIBA, Tokyo (JP)

(72) Inventors: Tatsuhiko GOTO, Kawasaki (JP); Akihiko ENAMITO, Kawasaki (JP); Osamu NISHIMURA, Kawasaki (JP)

(73) Assignee: KABUSHIKI KAISHA TOSHIBA, Tokyo (JP)

(21) Appl. No.: 17/896,289

(22) Filed: Aug. 26, 2022

(30) Foreign Application Priority Data
Feb. 14, 2022 (JP) 2022-020722

(51) Int. Cl. G01M 5/00; H04R 1/40; H04R 3/00; H04R 1/08; H04R 1/32

(52) U.S. Cl. CPC G01M 5/0066; H04R 1/406; H04R 3/005; H04R 1/08; H04R 1/326; G01M 5/0033

(57) ABSTRACT

According to one embodiment, an acoustic diagnostic apparatus includes a speaker, a sound receiving unit, a positioning mechanism, first through third calculation units, and an evaluation unit. The speaker emits a sound wave to a diagnosis target. The sound receiving unit includes two microphones to receive a sound wave from the target. The positioning mechanism positions the sound receiving unit. The first calculation unit calculates impulse responses of the microphones. The second calculation unit calculates, based on the impulse responses, an intensity value on a measurement axis passing through the microphones. The third calculation unit calculates a sound absorption coefficient from the intensity value. The evaluation unit diagnoses the target by evaluating an acoustic characteristic based on a change in the sound absorption coefficient.

### CROSS-REFERENCE TO RELATED APPLICATIONS

This application is based upon and claims the benefit of priority from Japanese Patent Application No. 2022-020722, filed Feb. 14, 2022; the entire contents of which are incorporated herein by reference.

### FIELD

Embodiments described herein relate generally to an acoustic diagnostic apparatus, an acoustic diagnostic method, and an acoustic diagnostic program.

### BACKGROUND

In a building or infrastructure, a change in rigidity caused by a change in welding and joining conditions of the structure, a change in structure damping characteristic caused by peeling of an internal coating material such as a damping material, or a change in strength caused by rust, a crack, or hollowing of an internal structure may occur as deterioration over time. Conventionally, periodic deterioration evaluation is performed by hammering or the like.

### BRIEF DESCRIPTION OF THE DRAWINGS

FIG. 1 is a block diagram of an acoustic diagnostic apparatus according to an embodiment.

FIG. 2 is a block diagram showing the hardware of a diagnostic processing unit shown in FIG. 1.

FIG. 3 is a timing chart showing a Logss signal based on equation (3) set with predetermined values.

FIG. 4 is a timing chart showing a Logss signal obtained by shifting the signal shown in FIG. 3 by a predetermined value.

FIG. 5 is a timing chart showing the spectrogram of the Logss signal after the shift shown in FIG. 4.

FIG. 6 is a timing chart showing the relationship between the frequency and the time in the spectrogram of the. Logss signal given by equations (6) to (8).

FIG. 7 is a timing chart showing a spectrogram when a harmonic distortion occurs in the Logss signal with the spectrogram shown in FIG. 6.

FIG. 8 is a timing chart showing impulse responses each obtained by converting, based on the inverse characteristic of the Logss signal, the response curve of the Logss signal with the spectrogram shown in FIG. 7.

FIG. 9 is a graph showing a result of calculating, based on equation (9), the occurrence times of the distortion characteristics shown in FIG. 8.

FIG. 10 is a graph showing a result of calculating, based on equation (10), the occurrence times of the distortion characteristics shown in FIG. 8 in the impulse responses.

FIG. 11 is a timing chart showing an example of an impulse response.

FIG. 12 is an enlarged view of a region Rb corresponding to the nonlinear characteristic of the impulse response.

FIG. 13 is a graph of an example of measurement of active intensity.

FIG. 14 is a graph of an example of measurement of reactive intensity.

FIG. 15 is a view showing an example of the positional relationship among the first microphone and the second microphone installed at arbitrary positions, a diagnosis target object, a speaker, and a mirror image sound source.

FIG. 16 is a view showing the positional relationship among the first microphone and the second microphone installed on a speaker axis, the diagnosis target object, the speaker, and the mirror image sound source.

FIG. 17 is a flowchart illustrating the procedure of diagnosis executed by a diagnostic processing unit.

FIG. 18 is a perspective view showing the first structure example of a positioning mechanism.

FIG. 19 is a perspective view of the positioning mechanism that holds a sound receiving unit according to a modification.

FIG. 20 is a view showing the positional relationship among six microphones of the sound receiving unit shown in FIG. 19.

FIG. 21 is a perspective view showing the second structure example of the positioning mechanism.

FIG. 22 is a view schematically showing the function of an influence exclusion plate shown in FIG. 20.

FIG. 23 is a block diagram showing an example of the functional arrangement of an acoustic diagnostic apparatus according to the second embodiment.

FIG. 24 is a view showing the arrangement of the first microphone and the second microphone of the acoustic diagnostic apparatus according to the second embodiment.

FIG. 25 is a view schematically showing a region of interest to the diagnosis target object.

FIG. 26 is a view showing a modification of a sound receiving unit.

FIG. 27 is a perspective view showing the first structure example of a positioning mechanism when viewed from the first direction.

FIG. 28 is a perspective view showing the first structure example of the positioning mechanism when viewed from the second direction.

FIG. 29 is a perspective view showing the second structure example of the positioning mechanism when viewed from the first direction.

FIG. 30 is a perspective view showing the second structure example of the positioning mechanism when viewed from the second direction.

### DETAILED DESCRIPTION

According to one embodiment, an acoustic diagnostic apparatus includes a speaker, a sound receiving unit, a positioning mechanism, an impulse response calculation unit, an intensity calculation unit, a sound absorption coefficient calculation unit, and a sound absorption coefficient change evaluation unit. The speaker is configured to emit a sound wave for an acoustic vibration to a diagnosis target object. The sound receiving unit includes a first microphone and a second microphone each configured to receive a sound wave from the diagnosis target object. The positioning mechanism is configured to position the sound receiving unit. The impulse response calculation unit is configured to calculate impulse responses of the first microphone and the second microphone based on sound reception signals of the first microphone and the second microphone, respectively. The intensity calculation unit is configured to calculate, based on the impulse responses of the first microphone and the second microphone, a first intensity value on a measurement axis passing through the first microphone and the second microphone. The sound absorption coefficient calculation unit is configured to calculate a first sound absorption coefficient from the first intensity value. The sound absorption coefficient change evaluation unit is configured to diagnose the diagnosis target object by evaluating an acoustic characteristic based on a change in the first sound absorption coefficient.

According to one embodiment, an acoustic diagnostic method includes: causing a speaker to emit a sound wave for an acoustic vibration to a diagnosis target object by continuously inputting an acoustic vibration signal; calculating, based on sound reception signals output from a first microphone and a second microphone sequentially positioned at a plurality of measurement points and each configured to receive a sound wave from the diagnosis target object, impulse responses of the first microphone and the second microphone, respectively; calculating, based on the impulse responses of the first microphone and the second microphone, a first intensity value on a measurement axis passing through the first microphone and the second microphone; calculating a sound absorption coefficient from the first intensity value; and diagnosing the diagnosis target object by evaluating an acoustic characteristic based on a change in the sound absorption coefficient.

According to one embodiment, a non-transitory computer-readable storage medium stores an acoustic diagnostic program for causing a computer, including a processor and a storage device, to execute functions of the impulse response calculation unit, the intensity calculation unit, the sound absorption coefficient calculation unit, and the sound absorption coefficient change evaluation unit of the acoustic diagnostic apparatus.

Embodiments will be described below with reference to the accompanying drawings.

### First Embodiment

(Functional Arrangement)

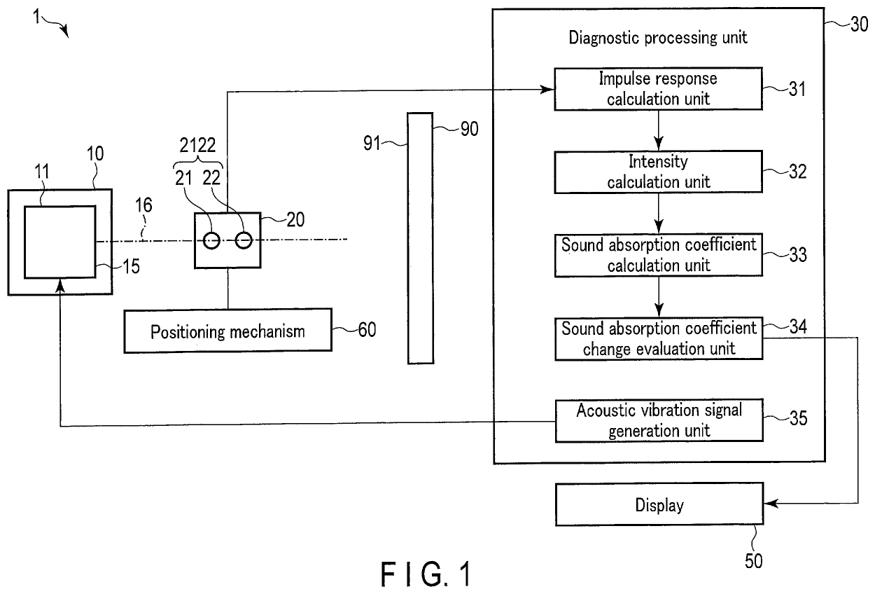

The functional arrangement of an acoustic diagnostic apparatus according to the first embodiment will be described with reference to FIG. 1. FIG. 1 is a block diagram showing an example of the functional arrangement of an acoustic diagnostic apparatus 1 according to the first embodiment. The acoustic diagnostic apparatus 1 is an apparatus that diagnoses a diagnosis target object 90 using a sound wave.

The acoustic diagnostic apparatus 1 includes an acoustic vibration unit 10, a sound receiving unit 20, a diagnostic processing unit 30, a display 50, and a positioning mechanism 60.

The acoustic vibration unit 10 applies an acoustic vibration to the diagnosis target object 90. Applying an acoustic vibration to the diagnosis target object 90 indicates emitting a sound wave to the diagnosis target object 90 and applying a vibration to the diagnosis target object 90. For example, the acoustic vibration unit includes a speaker 11. The speaker 11 emits a sound wave for an acoustic vibration to the diagnosis target object 90.

The speaker 11 emits a sound wave forward from a front 15. The speaker 11 is arranged so that the front 15 faces the diagnosis target object 90. The diagnosis target object 90 includes a plane 91. The speaker 11 is arranged so that the front 15 of the speaker 11 is parallel to the plane 91 of the diagnosis target object 90. An axis passing through the sound source center of the speaker 11 and perpendicular to the front of the speaker 11 will be referred to as a speaker axis 16 hereinafter. A direction away from the speaker 11 on the speaker axis 16 will be referred to as the emission direction of the sound wave for an acoustic vibration.

The sound receiving unit 20 includes two or more microphones. The microphone will simply be referred to as mic hereinafter. For example, the sound receiving unit 20 includes a first microphone 21 and a second microphone 22. In other words, the sound receiving unit 20 includes a microphone group 2122 including the two microphones 21 and 22. Each of the microphones 21 and 22 receives the sound wave, and outputs an electrical sound reception signal that reflects a sound pressure. The sound wave received by each of the microphones 21 and 22 includes an evaluation target sound including a sound wave reflected from the diagnosis target object 90 and a vibration radiated sound from the diagnosis target object 90, a radiated sound from the speaker 11, and an ambient reflected sound.

The diagnostic processing unit 30 drives the speaker 11, and also diagnoses the diagnosis target object 90 based on the sound reception signals of the microphones 21 and 22.

The display 50 displays a diagnosis result by the diagnostic processing unit 30.

The diagnostic processing unit 30 includes an impulse response calculation unit 31, an intensity calculation unit 32, a sound absorption coefficient calculation unit 33, a sound absorption coefficient change evaluation unit 34, and an acoustic vibration signal generation unit 35.

The impulse response calculation unit 31 calculates the impulse responses of the first microphone 21 and the second microphone 22 based on the sound reception signals of the first microphone 21 and the second microphone 22, respectively.

The intensity calculation unit 32 calculates an intensity value on a measurement axis passing through the first microphone 21 and the second microphone 22 based on the impulse responses of the first microphone 21 and the second microphone 22.

The sound absorption coefficient calculation unit 33 calculates a sound absorption coefficient from the intensity value. The sound absorption coefficient calculation unit 33 calculates a sound absorption coefficient using the intensity values at a plurality of measurement points.

The sound absorption coefficient change evaluation unit 34 diagnoses the diagnosis target object 90 by evaluating an acoustic characteristic based on a change in sound absorption coefficient.

The acoustic vibration signal generation unit 35 generates an acoustic vibration signal for causing the speaker 11 to emit a sound wave for an acoustic vibration, and continuously inputs the acoustic vibration signal to the speaker 11. In response to the input of the acoustic vibration signal, the speaker 11 emits a sound wave for an acoustic vibration. The acoustic vibration signal is a TSP (Time Stretched Pulse) signal. For example, the acoustic vibration signal is a Logss (Log Swept Sine) signal, which is a kind of TSP signal and capable of separating a nonlinear characteristic.

The positioning mechanism 60 positions the sound receiving unit 20. The positioning mechanism 60 arranges the first microphone 21 and the second microphone 22 on the speaker axis 16. Furthermore, the positioning mechanism 60 holds the sound receiving unit 20 to be movable along the speaker axis.

(Hardware Arrangement)

The hardware arrangement of the diagnostic processing unit 30 will be described next. The diagnostic processing unit 30 is formed by a computer. For example, the diagnostic processing unit 30 is formed by a personal computer, a server computer, or the like.

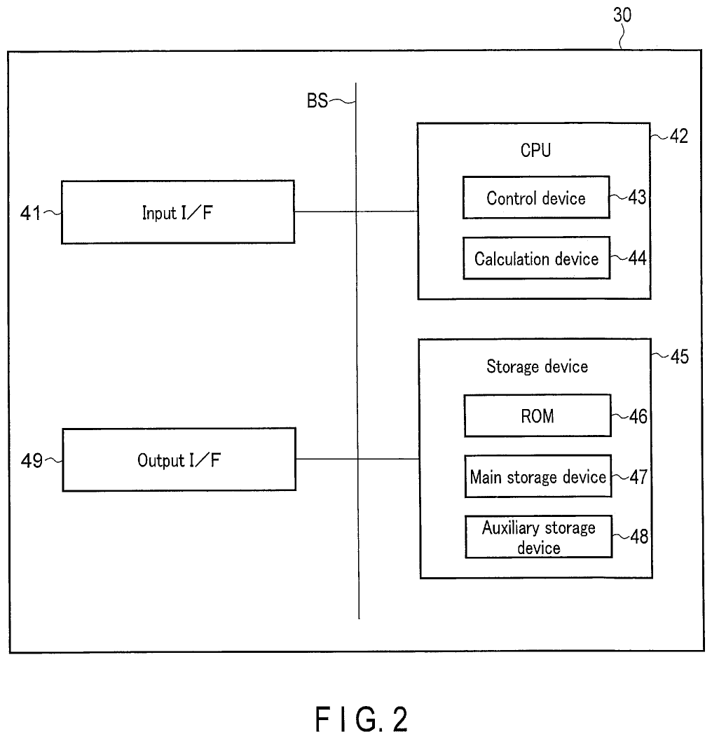

FIG. 2 is a block diagram showing an example of the hardware arrangement of the diagnostic processing unit according to the embodiment. As shown in FIG. 2, the diagnostic processing unit 30 includes an input I/F 41, a CPU 42, a storage device 45, and an output I/F 49. The diagnostic processing unit may additionally include another peripheral device.

The input I/F 41, the CPU 42, the storage device 45, and the output I/F 49 are electrically connected via a bus BS, and exchange data and commands via the bus BS.

The input I/F 41 is a device that receives a signal from the outside, converts the signal into data, and transfers the data to the CPU 42 and the storage device 45.

The output I/F 49 is a device that receives data from the CPU 42 and the storage device 45, converts the data into signals, and outputs the signals.

The storage device 45 stores programs and data necessary for processing executed by the CPU 42. The CPU 42 performs various processes by reading out the necessary programs and data from the storage device 45 and executing them.

The storage device 45 includes a ROM 46, a main storage device 47, and an auxiliary storage device 48. The main storage device 47 and the auxiliary storage device 48 exchange programs and data.

The ROM 46 stores a program (BIOS) for controlling the CPU 42 at the time of activation.

The main storage device 47 stores the programs and data temporarily necessary for the processing of the CPU 42. For example, the main storage device 47 is formed by a volatile memory such as a RAM (Random Access Memory).

The auxiliary storage device 48 stores programs and data supplied via an external device or a network, and provides the programs and data temporarily necessary for the processing of the CPU 42 to the main storage device 47. For example, the auxiliary storage device 48 is formed by a nonvolatile memory such as an HDD (Hard Disk Drive) or an SSD (Solid State Drive).

The CPU 42 is a processor and is hardware for processing data and commands. The CPU 42 includes a control device 43 and a calculation device 44.

The control device 43 controls the input I/F 41, the calculation device 44, the storage device 45, and the output I/F 49.

The calculation device 44 loads the programs and data from the main storage device 47, executes the programs to process data, and provides the processed data to the main storage device 47.

In this hardware arrangement, the CPU 42 and the storage device 45 form the respective units of the diagnostic processing unit 30, that is, the impulse response calculation unit 31, the intensity calculation unit 32, the sound absorption coefficient calculation unit 33, the sound absorption coefficient change evaluation unit 34, and the acoustic vibration signal generation unit 35.

For example, the CPU 42 loads the program for executing the function of the diagnostic processing unit 30 from the auxiliary storage device 48 into the main storage device 47, and executes the loaded program, thereby performing the operation of the diagnostic processing unit 30. The program is stored in a non-transitory computer-readable storage medium. That is, the auxiliary storage device 48 includes the non-transitory computer-readable storage medium storing the program.

(Acoustic Vibration Signal)

As described above, the acoustic vibration signal is a TSP (Time Stretched Pulse) signal. As one example of the TSP signal, a Logss (Log Swept Sine) signal will be described. A method of calculating the distortion occurrence time in the Logss signal will be described. For example, the definitional equation of the frequency characteristic of the Logss signal is represented using equations (1) to (3) below. Note that N represents the length of the Logss signal, q represents an arbitrary real number (J is a multiple of 2), N and q are setting variables, and j represents an imaginary number.

$$LOGSS ( i ) = \{ \begin{matrix}1 & ( i = 0 ) \\ \frac{exp \{ - j α \times i log ( i ) \}}{\sqrt{i}} & ( 1 \leq i \leq \frac{N}{2} ) \\ \frac{exp \{ - j α \times ( N - i ) log ( N - i ) \}}{\sqrt{N - 1}} & ( \frac{N}{2} + 1 \leq i \leq N - 1 )\end{matrix} \qquad ( 1 )$$

$$J = ( q ) \times N \qquad ( 2 )$$

$$α = \frac{J π}{\frac{N}{2} log ( \frac{N}{2} )} \qquad ( 3 )$$

Based on equations (1) to (3), the Logss signal is given by equation (4) below. Re represents a real part and IFFT represents inverse Fourier transformation.

logss Re[IFFT(LOGSS)] (4)

Note that the TSP signal generally used is given by equation (5) below in which m represents an integer.

$$TSP ( i ) = \{ \begin{matrix}exp \{ - j 4 m π \times {i}^{2} / {N}^{2} \} & ( 0 \leq i \leq \frac{N}{2} ) \\ exp \{ j 4 m π \times {( N - i )}^{2} / {N}^{2} \} & ( \frac{N}{2} + 1 \leq i \leq N - 1 )\end{matrix} \qquad ( 5 )$$

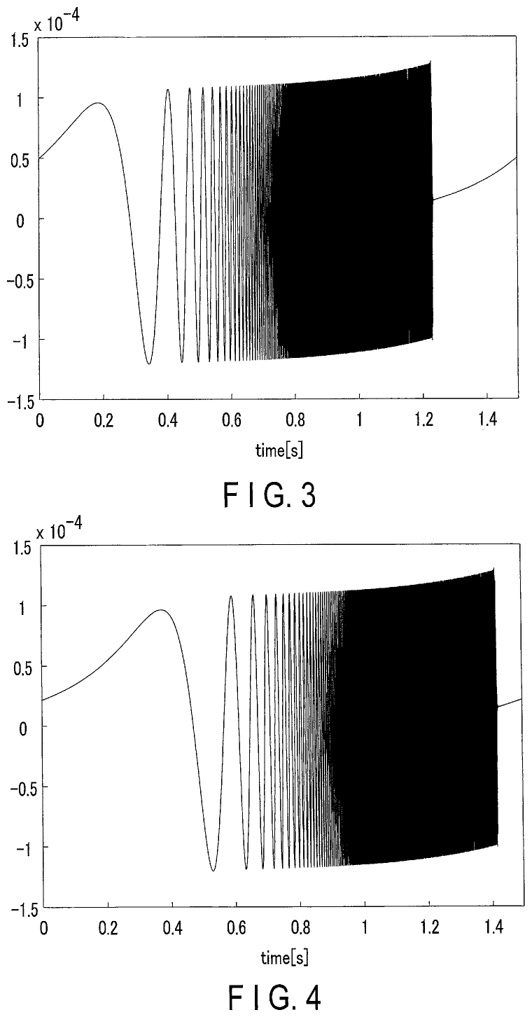

At this time, if a sampling frequency fₛ is set to 44.1 KHz, the length N of the Logss signal is set to 65536 (2¹⁶), and q is set to ¾, the signal given by equation (4) is represented, as shown in FIG. 3. A signal obtained by shifting the signal shown in FIG. 3 by (N−J)/2 is represented, as shown in FIG. 4. In FIGS. 3 and 4, the ordinate represents the level of a speaker application voltage (the level is adjusted by a connected speaker amplifier), and the abscissa represents the time [s]. The Logss signal is generated based on equations (1) to (4), and the signal obtained by shifting the signal by (N−J)/2 is used as an acoustic vibration signal, that is, an input signal to the speaker. Note that the shift amount is not limited to the above one. For example, as shown in FIG. 4, a tap value from 0 s (1 tap) to 0.1 s (0.1×fₛ tap) is set so that a change in a value close to the initial tap value is small.

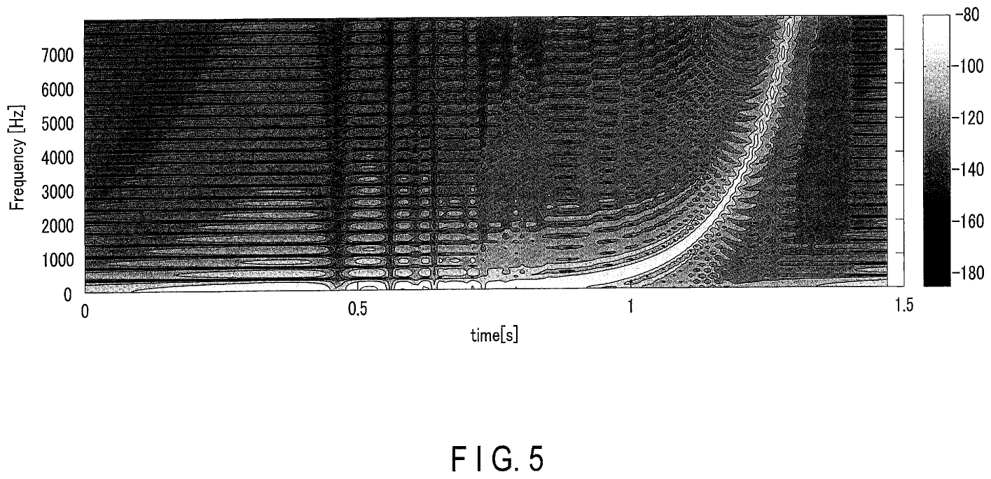

FIG. 5 shows the spectrogram of the Logss signal after the shift shown in FIG. 4. The ordinate represents the frequency [Hz] and the abscissa represents the time [s]. In the spectrogram shown in FIG. 5, by exchanging the ordinate and the abscissa, it will be found that a logarithmic change is obtained. That is, the logarithmic frequency is proportional to the time and the frequency is an exponential function of the time. Therefore, the relationship between the time and the frequency in the spectrogram of the Logss signal is given by equations (6) to (8) below. Note that t_{offset} represents the offset time, and shift represents the above-described shift amount of the Logss signal.

$$t = \frac{J}{{f}_{s} log ( \frac{N}{2} )} log ( f \times \frac{N}{{f}_{s}} ) + {t}_{offset} \qquad ( 6 )$$

$${t}_{offset} = \frac{J}{{f}_{s} log ( \frac{N}{2} )} + \frac{shift}{{f}_{s}} \qquad ( 7 )$$

$$shift = \frac{N - J}{2} \qquad ( 8 )$$

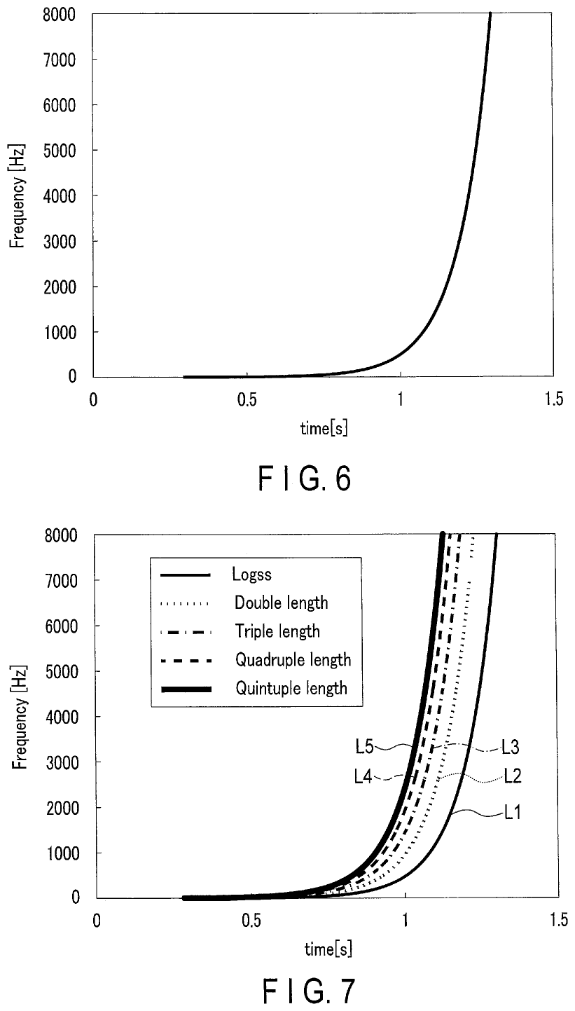

FIG. 6 is a timing chart showing the relationship between the time and the frequency in the spectrogram of the Logss signal given by equations (6) to (8) above. In FIG. 6, the ordinate represents the frequency [Hz] and the abscissa represents the time [s].

At this time, if a harmonic distortion occurs in the Logss signal when there is no dynamic characteristic, a timing chart shown in FIG. 7 is obtained. FIG. 7 shows the spectrogram obtained when a harmonic distortion occurs in the Logss signal with the spectrogram shown in FIG. 6. A line L1 is the curve of a basic response given by equations (6) to (8), a line L2 is the curve of the second harmonic response (the response curve of a first-order distortion), a line L3 is the curve of the third harmonic response (the curve of a second-order distortion), a line L4 is the curve of the fourth harmonic response (the curve of a third-order distortion), and a line L5 is the curve of the fifth harmonic response (the curve of a fourth-order distortion).

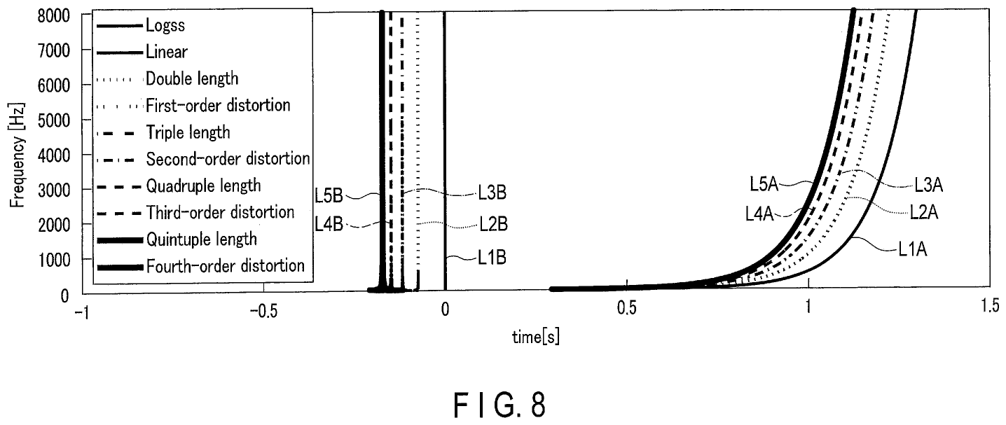

When such harmonic distortion occurs in the Logss signal, the curve of the above-described measured response is converted based on the inverse characteristic of the Logss signal, thereby obtaining a timing chart shown in FIG. 8. FIG. 8 shows an impulse response obtained by converting the response curve of the Logss signal with the spectrogram shown in FIG. 7 based on the inverse characteristic of the Logss signal. The ordinate represents the frequency [Hz] and the abscissa represents the time [s]. Lines L1A, L2A, L3A, L4A, and L5A are the response curves of the lines L1 to L5, respectively. A line L1B represents an impulse response corresponding to the basic response. A line L2B represents an impulse response corresponding to the second harmonic response (the distortion characteristic of the first-order distortion). A line L3B represents an impulse response corresponding to the third harmonic response (the distortion characteristic of the second-order distortion). A line L4B represents an impulse response corresponding to the fourth harmonic response (the distortion characteristic of the third-order distortion). A line L5B represents an impulse response corresponding to the fifth harmonic response (the distortion characteristic of the fourth-order distortion). The thus calculated impulse response corresponding to the harmonic response appears in a time region before time 0, that is, in a negative time region (a region in a non causal direction). If, however, the distance between the speaker and the microphone is long, the rising time of the linear response is delayed, and thus the impulse response corresponding to the harmonic response may occur in a positive time region. A description will be provided here under the condition that there is no time delay (no dynamic characteristic). The impulse response corresponding to the harmonic response is separated into distortions of respective orders in the region in the non-causal direction. In this embodiment, by using the Logss signal as an input signal, it is possible to separate the impulse response into distortions of respective orders, and analyze the distortions of the respective orders using the distortion characteristics of the distortions of the respective orders. In normal TSP, only the linear response can be obtained.

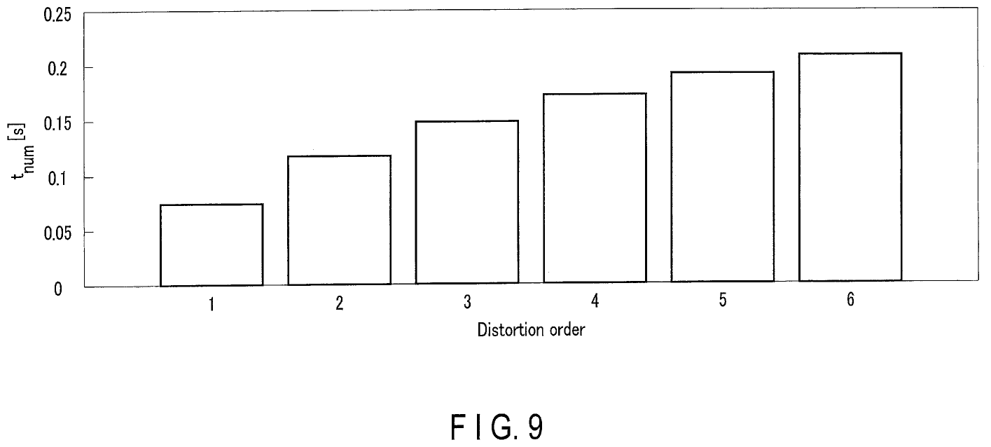

Furthermore, by separating the distortion characteristic, as described above, the distortion characteristics of the respective orders are separated into different time regions. At this time, the occurrence time (−t(num) [s]) of the distortion characteristic of each order is given by equation (9) below where num represents the distortion order. For example, by making the above-described settings, the occurrence times of the distortion characteristics shown in FIG. 8 are as shown in FIG. 9. In FIG. 9, the abscissa represents the distortion order and the ordinate represents the time [s].

$$\begin{matrix}{t}_{num} = \frac{J}{{f}_{s} log ( \frac{N}{2} )} \{ log ( \frac{N ( num + 1 ) {f}_{c}}{{f}_{s}} ) - log ( \frac{{Nf}_{c}}{{f}_{s}} ) \} \\ = \frac{J}{{f}_{s} log ( \frac{N}{2} )} log ( num + 1 )\end{matrix} \qquad ( 9 )$$

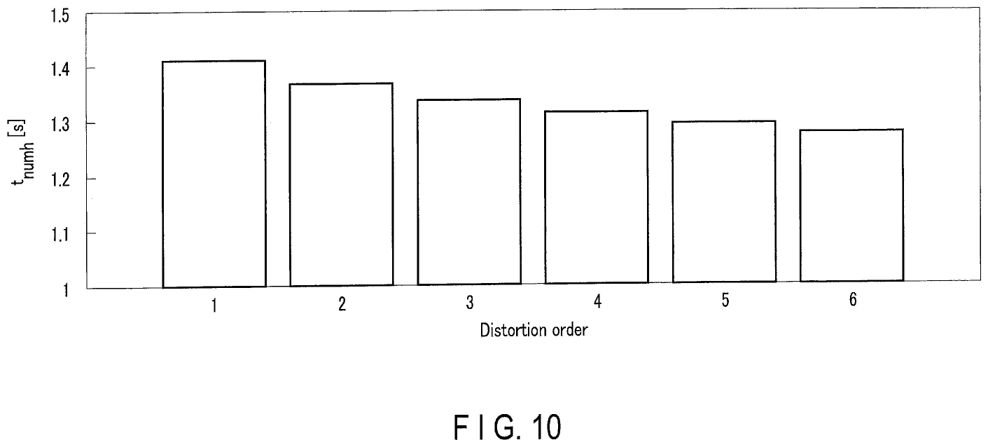

Then, based on the occurrence time of the distortion characteristic of each order with reference to the impulse response corresponding to the basic response, the distortion occurrence time in the derived impulse response is given by equation (10) below, because of the repeatability of discrete Fourier transformation.

$${t}_{numh} = \{ \begin{matrix}\frac{N}{{f}_{s}} - {t}_{num} + {t}_{a} & ( {t}_{num} > {t}_{a} ) \\ {t}_{a} - {t}_{num} & ( {t}_{num} < {t}_{a} )\end{matrix} \qquad ( 10 )$$

where ta represents the delay time (to also be referred to as a “wasted time” hereinafter) of the dynamic characteristic, and is decided by L/c using the distance L between the speaker and the microphone in which c represents the speed of sound. More strictly, the delay characteristic of the speaker or that of the system is also added to ta. ta corresponds to the rising time of the first wave in the causal direction, satisfying causality, as the opposite direction of the non causal direction. If, for example, the distance L between the speaker and the microphone is sufficiently short and ta can be regarded as 0, in the above-described settings, the distortion occurrence times in the impulse response are as shown in FIG. 10. In FIG. 10, the abscissa represents the distortion order and the ordinate represents the time [s].

(Method of Calculating Impulse Response from TSP Signal)

The above-described TSP signal is input as a speaker application voltage to the speaker amplifier, thereby driving the speaker 11.

Each of the microphones 21 and 22 of the sound receiving unit 20 measures, as a sound pressure, a direct sound from the speaker 11, a reflected sound from the diagnosis target object 90, and a vibration radiated sound from the diagnosis target object 90, all of which accompany the acoustic vibration of the speaker. In the case of LDV measurement, the vibration velocity of the diagnosis target object 90 is measured.

The impulse response calculation unit 31 calculates an impulse response based on the speaker application voltage and a microphone acquisition sound pressure response. The speaker application voltage is generated based on signals obtained by arranging TSP signals (Logss signals or the like) for a predetermined number of times. The impulse response calculation unit averages the sound pressure changes of the second time and thereafter in the sound reception signal by setting the length of the TSP signal (Logss signal or the like) as the length for once. The impulse response calculation unit 31 performs fast Fourier transformation (FFT) for the averaged signal. The impulse response calculation unit multiplies the signal after the FFT processing by the inverse characteristic of the TSP signal (Logss signal or the like) in the speaker application voltage in the frequency domain. The impulse response calculation unit calculates an impulse response by performing inverse fast Fourier transformation (inverse FFT) for the signal obtained by performing the multiplication processing.

Note that in accordance with the frequency band in which the speaker 11 can output a signal, the TSP signal may be filtered using a bandpass filter, thereby obtaining the speaker application voltage. This can increase the output level (speaker amplifier) of the speaker. At this time, the impulse response calculation unit may appropriately correct the influence of filtering using the bandpass filter in the processing in the frequency domain.

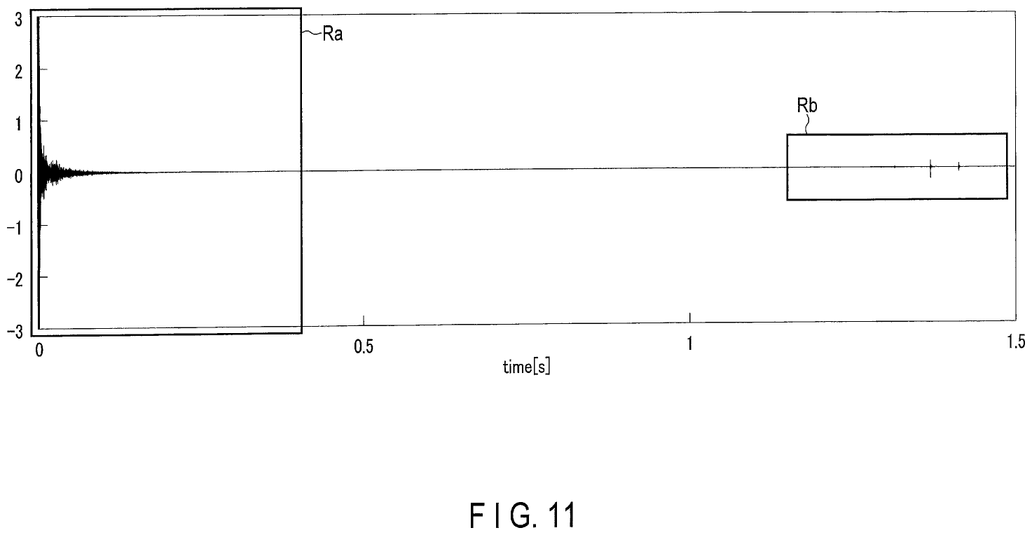

FIG. 11 is a timing chart showing an example of the impulse response calculated, as described above, in the above-described settings. In FIG. 11, the abscissa represents the time [s] and the ordinate represents the level of the impulse response. The impulse response shown in FIG. 11 is derived from the microphone response of the sound receiving unit 20 with respect to the acoustic vibration of the speaker based on the Logss signal. The impulse response is the dynamic characteristic including the speaker characteristic, the acoustic space characteristic, and the acoustic characteristic of the diagnosis target object 90. Therefore, the linear characteristic of the dynamic characteristic appears in a region Ra, and the nonlinear characteristic (distortion characteristic) of the dynamic characteristic appears in a region Rb. The region Ra corresponds to a period (about several sec) from the time immediately before the time corresponding to the peak value of the impulse response to the time when a residual response (reverberation response) occurs (linear characteristic section). The region Rb is set in accordance with the distortion occurrence times shown in FIG. 10 in a region other than the region Ra.

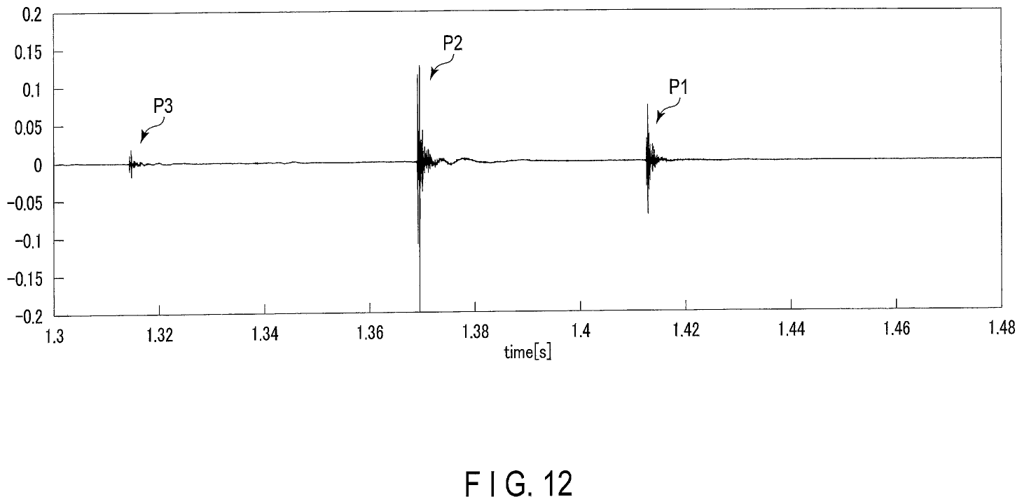

FIG. 12 is an enlarged view of the region Rb corresponding to the nonlinear characteristic of the impulse response. In FIG. 12, the abscissa represents the time and the ordinate represents the level of the impulse response. Based on FIG. 10, a first-order distortion p1, a second-order distortion p2, and a third-order distortion p3 appear in the order shown in FIG. 12.

(Intensity Calculation Method)

A method of obtaining the intensity on a line segment connecting the first microphone 21 and the second microphone 22 installed at an interval of a distance d will be described next. With reference to the first microphone 21, the first microphone 21 and the second microphone 22 are arranged in this order in the positive direction of the intensity measurement axis.

When G₁(ω) and G₂(ω) represent transfer characteristics acquired via the first microphone 21 and the second microphone 22 at the time of acoustic vibration measurement, respectively, active intensity representing the flow of energy of a sound wave on the measurement axis can be obtained by:

$$I ( ω ) = \frac{- 1}{ω ρ d} Im ( {G}_{1}^{*} ( ω ) {G}_{2} ( ω ) ) \qquad ( 11 )$$

Note that each transfer characteristic is calculated by performing FFT for the impulse response. If the TSP signal is the Logss signal, 0 is appended to the extracted impulse response, and FFT is performed, thereby calculating each transfer characteristic.

Since the particle velocity is approximated using the two microphones 21 and 22 arranged at an interval of the distance d, the upper limit of the measurement range frequency is set to about fₘₐₓ=c/(10d) corresponding to λ=10d in consideration of the measurement accuracy.

Furthermore, reactive intensity indicating the sound pressure square gradient is obtained by:

$$Q ( ω ) = \frac{{G}_{1}^{*} ( ω ) {G}_{1} ( ω ) - {G}_{2}^{*} ( ω ) {G}_{2} ( ω )}{2 ω ρ d} \qquad ( 12 )$$

Note that, as described above, if the FFT value is used intact in a high frequency range of 1 KHz or more, display of the intensity characteristic is noisy. Therefore, with respect to the FFT value, a value obtained by performing, at frequencies of ±several Hz, the gain and phase averaging processing is returned to a complex number, and the intensity is calculated.

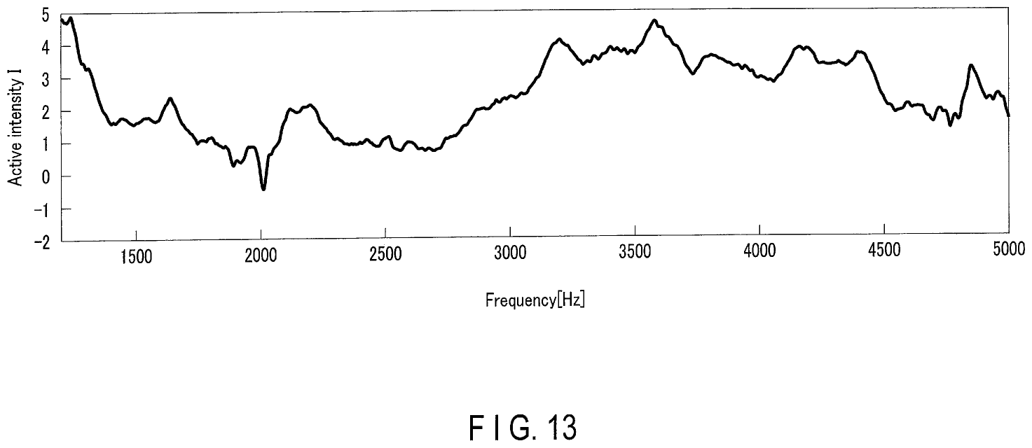

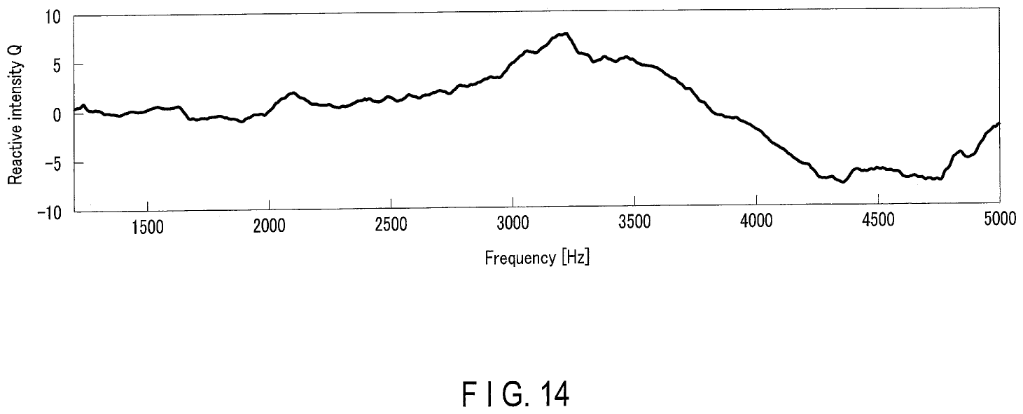

FIGS. 13 and 14 show examples of measurement when the distance d between the microphones is 5 mm. FIG. 13 is a graph of an example of measurement of active intensity. FIG. 14 is a graph of an example of measurement of reactive intensity. Note that as the FFT value, a value obtained by returning, to a complex number, a value obtained by performing, at frequencies of ±20 Hz, the gain and phase averaging processing is used.

(Method of Calculating Sound Absorption Coefficient)

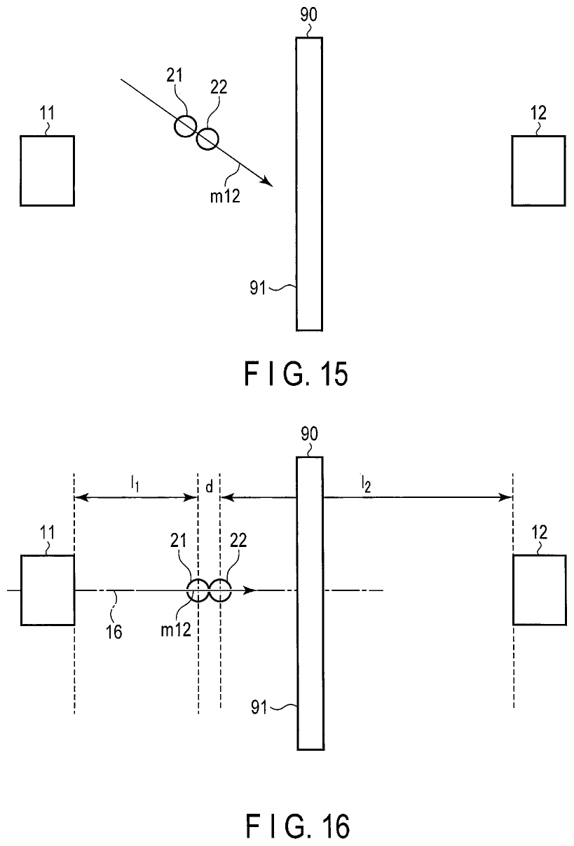

A method of obtaining a sound absorption coefficient will be described next. With reference to FIG. 15, consider a case in which the first microphone 21 and the second microphone 22 are installed at arbitrary positions. FIG. 15 is a view showing an example of the positional relationship among the first microphone 21 and the second microphone 22 installed at arbitrary positions, the diagnosis target object 90, the speaker 11, and a mirror image sound source 12. The mirror image sound source 12 is a virtual sound source located plane-symmetrically with the speaker 11 with respect to the plane 91 of the diagnosis target object 90 facing the speaker 11.

As an example of the case in which the first microphone 21 and the second microphone 22 are installed at arbitrary positions, FIG. 15 shows a case in which a measurement axis m12 passing through the first microphone 21 and the second microphone 22 is not perpendicular to the plane 91 of the diagnosis target object 90.

The transfer characteristics to the first microphone 21 and the second microphone 22 installed at arbitrary positions are decided based on the transfer characteristics from the speaker 11 and the mirror image sound source 12, by:

G₁(ω)=q₁(ω)X₁₁(ω)+q₂(ω)X₂₁(ω)

G₂(ω)=q₁(ω)X₁₂(ω)+q₂(ω)X₂₂(ω) (13)

where q₁ represents the volume velocity of the speaker 11, q₂ represents the volume velocity of the mirror image sound source 12, X₁₁(ω) represents the transfer characteristic from the speaker 11 to the first microphone 21, X₁₂(ω) represents the transfer characteristic from the speaker 11 to the second microphone 22, X₂₁(ω) represents the transfer characteristic from the mirror image sound source 12 to the first microphone 21, and X₂₂(ω) represents the transfer characteristic from the mirror image sound source 12 to the second microphone 22.

Therefore, if there is no ambient reflection, the volume velocity of the speaker 11 and that of the mirror image sound source 12 are readily obtained by:

$$[ \begin{matrix}{q}_{1} ( ω ) \\ {q}_{2} ( ω )\end{matrix} ] = {[ \begin{matrix}{X}_{11} ( ω ) & {X}_{21} ( ω ) \\ {X}_{12} ( ω ) & {X}_{22} ( ω )\end{matrix} ]}^{- 1} [ \begin{matrix}{G}_{1} ( ω ) \\ {G}_{2} ( ω )\end{matrix} ] \qquad ( 14 )$$

The sound absorption coefficient is also obtained by:

$$α ( ω ) = 1 - \frac{{\vert {q}_{2} ( ω ) \vert}^{2}}{{\vert {q}_{1} ( ω ) \vert}^{2}} \qquad ( 15 )$$

Since, however, ambient reflection occurs on a floor or wall surface, such ideal measurement can rarely be performed.

Intensity on the measurement axis m12 passing through the first microphone 21 and the second microphone 22 installed at arbitrary positions is given by equation (16) below, where d represents the distance between the microphones.

$$I ( ω ) = \frac{- 1}{ω ρ d} Im ( {G}_{1}^{*} ( ω ) {G}_{2} ( ω ) ) \qquad ( 16 )$$

Equations (13) are substituted into equation (16), thereby obtaining

$$[ \begin{matrix}Im [ {X}_{11}^{*} ( ω ) {X}_{12} ( ω ) ] & Im [ {X}_{21}^{*} ( ω ) {X}_{22} ( ω ) ] & Im [ {X}_{11}^{*} ( ω ) {X}_{22} ( ω ) + {X}_{21}^{*} ( ω ) {X}_{12} ( ω ) ]\end{matrix} \\ Re [ {X}_{11}^{*} ( ω ) {X}_{22} ( ω ) - {X}_{21}^{*} ( ω ) {X}_{12} ( ω ) ] ] [ \begin{matrix}{\vert {q}_{1} ( ω ) \vert}^{2} \\ {\vert {q}_{2} ( ω ) \vert}^{2} \\ Re [ {q}_{1}^{*} ( ω ) {q}_{2} ( ω ) ] \\ Im [ {q}_{1}^{*} ( ω ) {q}_{2} ( ω ) ]\end{matrix} ] = - ω ρ dI ( ω ) \qquad ( 17 )$$

Therefore, by measuring intensity values at four or more measurement points, expression (18) below can be solved.

$$[ \begin{matrix}{\vert {q}_{1} ( ω ) \vert}^{2} \\ {\vert {q}_{2} ( ω ) \vert}^{2} \\ Re [ {q}_{1}^{*} ( ω ) {q}_{2} ( ω ) ] \\ Im [ {q}_{1}^{*} ( ω ) {q}_{2} ( ω ) ]\end{matrix} ] \qquad ( 18 )$$

Since, however, a constraint condition of equation (19) below is set, it is necessary to use a nonlinear optimization method (Lagrange multiplier or quasi-Newton method), and thus this method cannot be a simple sound absorption coefficient measurement method.

[Re[q₁*(ω)q₂(ω)]]²+[Im[q₁*(ω)q₂(ω)]]²=|q₁(ω)|²|q₂(ω)|² (19)

Next, with reference to FIG. 16, consider a case in which the first microphone 21 and the second microphone 22 are installed on the speaker axis 16, like this embodiment. FIG. 16 is a view showing the positional relationship among the first microphone 21 and the second microphone 22 installed on the speaker axis 16, the diagnosis target object 90, the speaker 11, and the mirror image sound source 12.

In this embodiment, both the first microphone 21 and the second microphone 22 are located on the speaker axis 16 perpendicular to the plane 91 of the diagnosis target object 90. That is, the measurement axis m12 is located on the speaker axis 16. In the arrangement relationship shown in FIG. 16, equations (20) below are obtained.

X₁₁*(ω)X₂₂(ω)=e^{jk(l}^{₁}^{-l}^{₂}⁾/(16π²l₁l₂)

X₂₁*(ω)X₁₂(ω)=e^{jk(l}^{₂}^{-l}^{₁}⁾/(16π²(l₁+d)(l₂+d)) (20)

where l₁ represents the distance between the speaker and the microphone 21 and l₂ represents the distance between the mirror image sound source and the microphone 22. This obtains expression (21) below. Especially, the phases coincide with each other.

(X₁₁*(ω)X₂₂(ω))*˜X₂₁*(ω)X₁₂(ω) (21)

Thus, expression (22) below is obtained.

Im[X₁₁*(ω)X₂₂(ω)q₁*(ω)q₂(ω)+X₂₁*(ω)X₁₂(ω)q₁(ω)q₂*(ω)]˜0 (22)

Therefore, equation (16) can be expressed by:

$$[ \begin{matrix}Im [ {X}_{11}^{*} ( ω ) {X}_{12} ( ω ) ] & Im [ {X}_{21}^{*} ( ω ) {X}_{22} ( ω ) ]\end{matrix} ] [ \begin{matrix}{\vert {q}_{1} ( ω ) \vert}^{2} \\ {\vert {q}_{2} ( ω ) \vert}^{2}\end{matrix} ] = - ω ρ dI ( ω ) \qquad ( 23 )$$

Furthermore, equations (24) hold.

X₁₁*(ω)X₁₂(ω)=e^{-jkd}/(16π²l₁(l₁+d))

X₂₁*(ω)X₂₂(ω)=e^{jkd}/(16π²l₂(l₂+d)) (24)

Thus, equations (25) below can be obtained.

$$[ \begin{matrix}1 / ( {l}_{1} ( {l}_{1} + d ) ) & - 1 / ( {l}_{2} ( {l}_{2} + d ) )\end{matrix} ] [ \begin{matrix}β ( ω {\vert {q}_{1} ( ω ) \vert}^{2} \\ β ( ω ) {\vert {q}_{2} ( ω ) \vert}^{2}\end{matrix} ] = I ( ω ) \\ β ( ω ) = sin ( kd ) / ( 16 {π}^{2} ω ρ d ) \qquad ( 25 )$$

If intensity values are measured at two or more measurement points, a value of a constant multiple of the magnitude of the volume velocity is obtained from equations (26) and (27) below. Subscripts a and b correspond to two measurement points a and b.

$$[ \begin{matrix}1 / ( {l}_{a 1} ( {l}_{a 1} + d ) ) & - 1 / ( {l}_{a 2} ( {l}_{a 2} + d ) ) \\ 1 / ( {l}_{b 1} ( {l}_{b 1} + d ) ) & - 1 / ( {l}_{b 2} ( {l}_{b 2} + d ) )\end{matrix} ] [ \begin{matrix}β ( ω ) {\vert {q}_{1} ( ω ) \vert}^{2} \\ β ( ω ) {\vert {q}_{2} ( ω ) \vert}^{2}\end{matrix} ] = [ \begin{matrix}{I}_{a} ( ω ) \\ {I}_{b} ( ω )\end{matrix} ] \qquad ( 26 )$$

$$[ \begin{matrix}β ( ω ) {\vert {q}_{1} ( ω ) \vert}^{2} \\ β ( ω ) {\vert {q}_{2} ( ω ) \vert}^{2}\end{matrix} ] = {[ \begin{matrix}\frac{1}{{l}_{a 1} ( {l}_{a 1} + d )} & - \frac{1}{{l}_{a 2} ( {l}_{a 2} + d )} \\ \frac{1}{{l}_{b 1} ( {l}_{b 1} + d )} & - \frac{1}{{l}_{b 2} ( {l}_{b 2} + d )}\end{matrix} ]}^{- 1} [ \begin{matrix}{l}_{a} ( ω ) \\ {l}_{b} ( ω )\end{matrix} ] \qquad ( 27 )$$

The sound absorption coefficient is obtained by equation (28) below. This is calculated at each frequency.

$$α ( ω ) = 1 - \frac{{\vert {q}_{2} ( ω ) \vert}^{2}}{{\vert {q}_{1} ( ω ) \vert}^{2}} = 1 - \frac{β ( ω ) {\vert {q}_{2} ( ω ) \vert}^{2}}{β ( ω ) {\vert {q}_{1} ( ω ) \vert}^{2}} \qquad ( 28 )$$

Note that if intensity values are measured at a plurality of measurement points on the speaker axis 16, a least square solution is obtained by a pseudo-inverse matrix, and it is possible to reduce the influence of measurement noise. A larger number of measurement points is more desirable.

If measurement is performed at three measurement points, for example, equation (29) is obtained. If an H matrix given by equation (30) is used, equation (29) is represented by equation (31) below.

$$[ \begin{matrix}1 / ( {l}_{a 1} ( {l}_{a 1} + d ) ) & - 1 / ( {l}_{a 2} ( {l}_{a 2} + d ) ) \\ 1 / ( {l}_{b 1} ( {l}_{b 1} + d ) ) & - 1 / ( {l}_{b 2} ( {l}_{b 2} + d ) ) \\ 1 / ( {l}_{c 1} ( {l}_{c 1} + d ) ) & - 1 / ( {l}_{c 2} ( {l}_{c 2} + d ) )\end{matrix} ] [ \begin{matrix}β ( ω ) {\vert {q}_{1} ( ω ) \vert}^{2} \\ β ( ω ) {\vert {q}_{2} ( ω ) \vert}^{2}\end{matrix} ] = [ \begin{matrix}{I}_{a} ( ω ) \\ {I}_{b} ( ω ) \\ {I}_{c} ( ω )\end{matrix} ] \qquad ( 29 )$$

$$H = [ \begin{matrix}1 / ( {l}_{a 1} ( {l}_{a 1} + d ) ) & - 1 / ( {l}_{a 2} ( {l}_{a 2} + d ) ) \\ 1 / ( {l}_{b 1} ( {l}_{b 1} + d ) ) & - 1 / ( {l}_{b 2} ( {l}_{b 2} + d ) ) \\ 1 / ( {l}_{c 1} ( {l}_{c 1} + d ) ) & - 1 / ( {l}_{c 2} ( {l}_{c 2} + d ) )\end{matrix} ] \qquad ( 30 )$$

$$[ \begin{matrix}β ( ω ) {\vert {q}_{1} ( ω ) \vert}^{2} \\ β ( ω ) {\vert {q}_{2} ( ω ) \vert}^{2}\end{matrix} ] = {H}^{T} {\{ {HH}^{T} \}}^{- 1} [ \begin{matrix}{I}_{a} ( ω ) \\ {I}_{b} ( ω ) \\ {I}_{c} ( ω )\end{matrix} ] \qquad ( 31 )$$

Furthermore, to prevent the row vectors of the H matrix given by equation (30) from resembling each other, if the number of measurement points is small, the distance between the measurement points is set sufficiently larger than the distance d between the microphones. For example, the distance between the measurement points is set to, for example, 2d or larger.

To reduce measurement noise, it is desirable to introduce a relaxation term given by equation (32) below, or apply truncated singular value decomposition.

$$[ \begin{matrix}β ( ω ) {\vert {q}_{1} ( ω ) \vert}^{2} \\ β ( ω ) {\vert {q}_{2} ( ω ) \vert}^{2}\end{matrix} ] = {H}^{T} {\{ {HH}^{T} + δ I \}}^{- 1} [ \begin{matrix}{I}_{a} ( ω ) \\ {I}_{b} ( ω ) \\ {I}_{c} ( ω )\end{matrix} ] \qquad ( 32 )$$

(Procedure of Diagnosis)

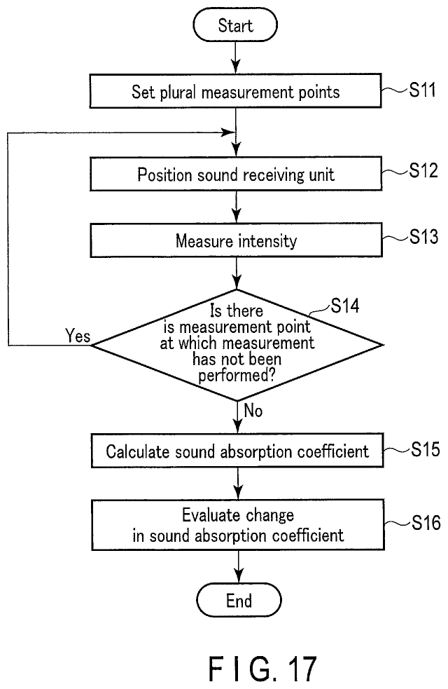

The procedure of diagnosis executed by the diagnostic processing unit 30 will be described next with reference to FIG. 17. FIG. 17 is a flowchart illustrating the procedure of diagnosis executed by the diagnostic processing unit 30.

In step S11, a plurality of measurement points at each of which the sound receiving unit 20 is arranged are set.

In step S12, the positioning mechanism 60 is used to move the sound receiving unit 20 to one of the measurement points and position it. The positioning mechanism 60 holds the sound receiving unit 20 so that the first microphone 21 and the second microphone 22 are located on the speaker axis 16. Furthermore, the positioning mechanism 60 moves the sound receiving unit 20 along the speaker axis 16 so that the microphones 21 and 22 are maintained on the speaker axis 16.

In step S13, the acoustic vibration signal generation unit 35 supplies an acoustic vibration signal to the speaker 11, and causes the speaker 11 to emit a sound wave for an acoustic vibration. The impulse response calculation unit 31 receives a sound reception signal from each of the microphones 21 and 22, and calculates the impulse response of each of the microphones 21 and 22. The intensity calculation unit 32 calculates an intensity value on the measurement axis passing through the microphones 21 and 22 based on the impulse responses of the microphones 21 and 22.

In step S14, if there is a measurement point at which the intensity value has not been measured (YES in step S14), the processes in steps S12 and S13 are repeated. If there is no measurement point at which the intensity value has not been measured (NO in step S14), the process advances to step S15.

In step S15, the sound absorption coefficient calculation unit 33 calculates a sound absorption coefficient using the intensity values at the plurality of measurement points.

In step S16, the sound absorption coefficient change evaluation unit 34 diagnoses the diagnosis target object by evaluating the acoustic characteristic based on a change in sound absorption coefficient.

(Diagnostic Method)

A diagnostic method executed by the sound absorption coefficient change evaluation unit 34 will be described next. Three diagnostic methods will now be described.

The first diagnostic method is a method generally used in deterioration diagnosis, in which comparison with a baseline is performed. In this method, sound absorption coefficient measurement is performed in advance at the time of occurrence of a failure mode (deterioration of a joining force, a welding defect, cracking, or hollowing), and the sound absorption coefficient baseline of the allowable range is measured. The measured sound absorption coefficient is compared with the sound absorption coefficient baseline, and it is determined whether transition is performed to a dangerous line. If, for example, the measured sound absorption coefficient exceeds the sound absorption coefficient baseline, an abnormal state is determined. By setting the frequency as the abscissa and plotting the measured sound absorption coefficient and the sound absorption coefficient baseline, determination of deterioration is performed.

The second diagnostic method is deterioration progress diagnosis by a change over time, and determines an abnormal state by determining, by monitoring a time-series change, whether the measured sound absorption coefficient tends to increase or decrease. By setting the frequency as the abscissa and plotting the measured sound absorption coefficient, the change tendency of the sound absorption coefficient over time is grasped.

The third diagnostic method is diagnosis of peeling of a damping material adhered to the diagnosis target object 90, and is a determination method using the fact that the diagnosis target object 90 such as a plate material (surface material) obtains the sound absorption characteristic by vibrating. In general, if the damping material peels off, the plate material vibrates, thereby increasing the sound absorption characteristic. By grasping the increasing tendency of the sound absorption characteristic based on the measured sound absorption coefficient, peeling of the damping material is determined.

(First Structure Example of Positioning Mechanism 60)

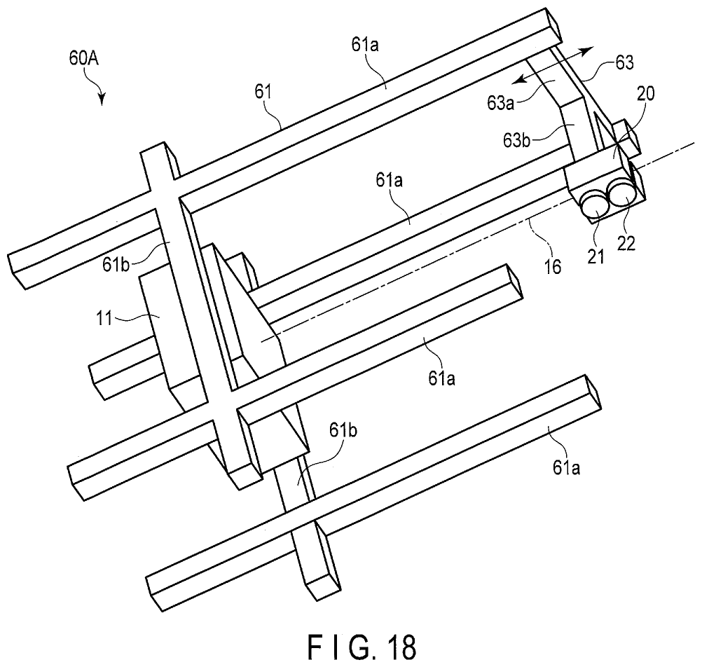

The first structure example of the positioning mechanism 60 will be described next with reference to FIG. 18. FIG. 18 is a perspective view showing the first structure example of the positioning mechanism 60, that is, a positioning mechanism 60A.

The positioning mechanism 60A shown in FIG. 18 includes a frame 61 that holds the speaker 11 and a slider 63 that holds the sound receiving unit 20.

The frame 61 includes four linear columns 61a and crossbars 61b that connect the columns 61a. The four columns 61a extend in parallel to each other. The crossbars 61b are fixed to the speaker 11. Each column 61a extends in parallel to the speaker axis 16 of the speaker 11. In other words, the speaker 11 is attached to the crossbars 61b so that the speaker axis 16 is parallel to the columns 61a.

The slider 63 is movable along the columns 61a of the frame 61. The slider 63 has a T shape, and includes a base portion 63a extending between the two columns 61a and an arm 63b extending from the base portion 63a. The two ends of the base portion 63a are connected to, for example, the two columns 61a via a linear guide. The arm 63b holds the sound receiving unit 20 so that the first microphone 21 and the second microphone 22 are located on the speaker axis 16.

(Modification of Sound Receiving Unit 20)

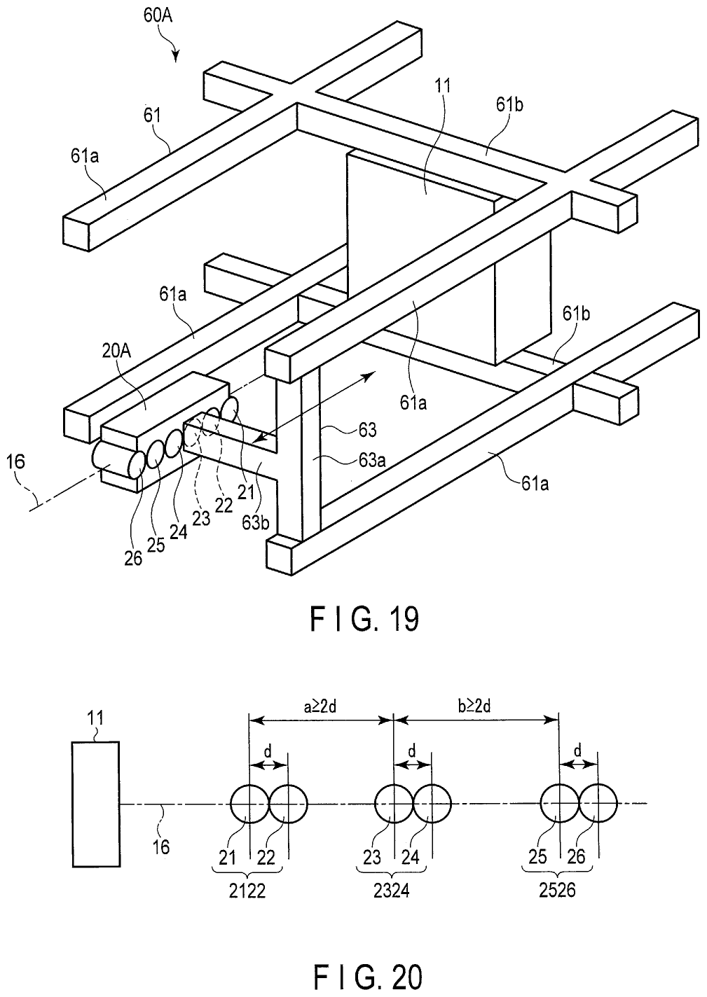

A modification of the sound receiving unit 20 will be described next with reference to FIGS. 19 and 20. FIG. 19 is a perspective view of the positioning mechanism 60A that holds a modification of the sound receiving unit 20, that is, a sound receiving unit 20A.

The sound receiving unit 20A shown in FIG. 19 has a line array microphone arrangement, and includes six microphones 21, 22, 23, 24, 25, and 26 arranged on a line. All of the six microphones 21 to 26 are arranged on the speaker axis 16.

FIG. 20 is a view showing an example of the positional relationship among the six microphones 21 to 26 of the sound receiving unit 20A. The six microphones 21 to 26 are divided into three microphone groups. That is, the sound receiving unit 20A includes a microphone group 2122 including the two microphones 21 and 22, a microphone group 2324 including the two microphones 23 and 24, and a microphone group 2526 including the two microphones 25 and 26.

The microphone interval between the microphone groups 2122, 2324, and 2526 is represented by d. An interval a between the microphone groups 2122 and 2324 is preferably 2d or longer. An interval b between the microphone groups 2324 and 2526 is preferably 2d or longer.

By using the sound receiving unit 20A, it is possible to measure intensity values at three measurement points at the same time. Thus, by using the sound receiving unit 20A, an attempt can be made to shorten the measurement time.

(Second Structure Example of Positioning Mechanism 60)

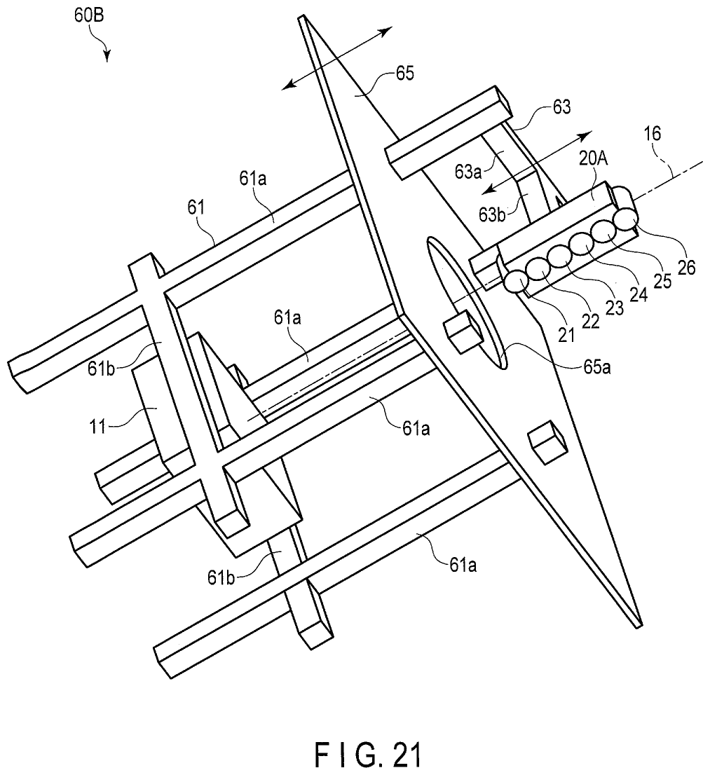

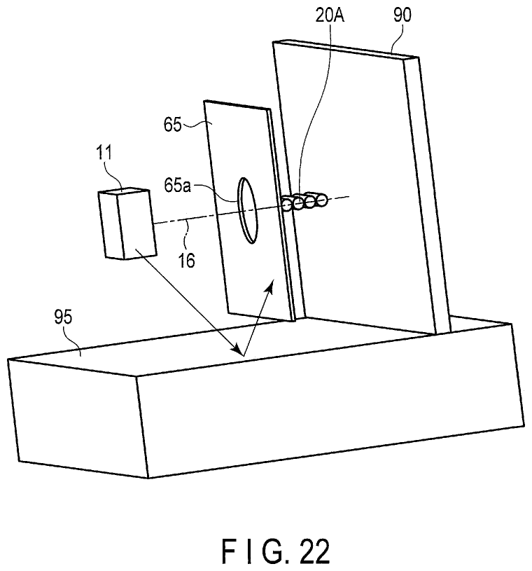

The second structure example of the positioning mechanism 60 will be described next with reference to FIGS. 21 and 22. FIG. 21 is a perspective view showing the second structure example of the positioning mechanism 60, that is, a positioning mechanism 60B. FIG. 22 is a view schematically showing the function of an influence exclusion plate 65.

The positioning mechanism 60B includes the influence exclusion plate 65 in addition to the components of the positioning mechanism 60A. The influence exclusion plate 65 is supported, by the four columns 61a of the frame 61, to be movable along the columns 61a. The influence exclusion plate 65 includes, at its center, a circular opening 65a having the speaker axis 16 as the center.

As shown in FIG. 22, the influence exclusion plate 65 blocks the reflected sound from a structure 95 such as a wall or floor. In the acoustic diagnostic apparatus 1 according to this embodiment, it is possible to significantly reduce the influence of ambient reflection for intensity measurement, and further reduce the influence of ambient reflection by using the positioning mechanism 60B.

As is apparent from the above description, instead of analyzing the actual operation sound from the diagnosis target object 90, the acoustic diagnostic apparatus 1 according to this embodiment can apply an acoustic vibration to the diagnosis target object 90, analyze a sound wave emitted from the diagnosis target object 90, acquire acoustic characteristic information of an analysis designation frequency band, and then determine deterioration.

### Second Embodiment

(Functional Arrangement)

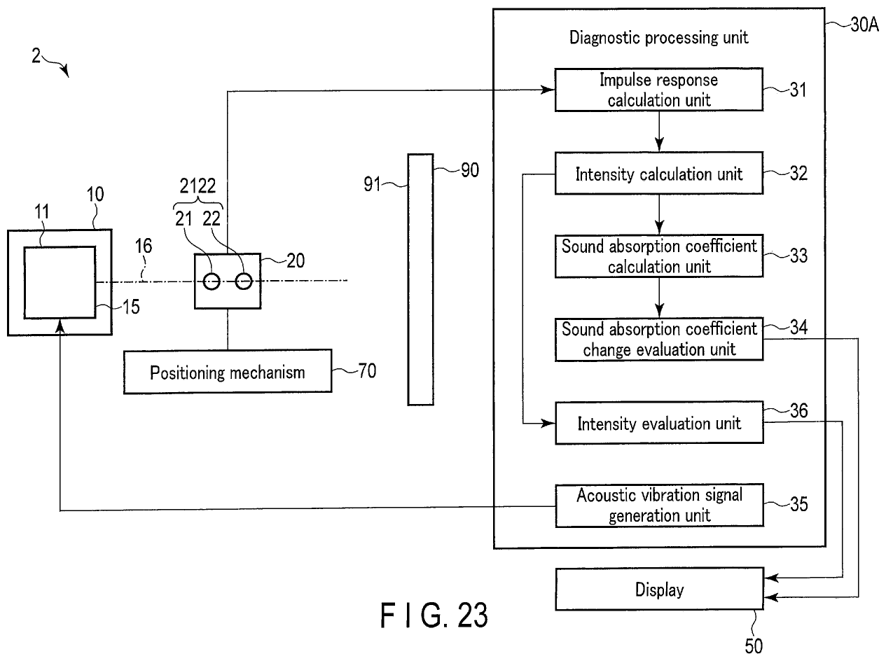

The functional arrangement of an acoustic diagnostic apparatus according to the second embodiment will be described with reference to FIG. 23. FIG. 23 is a block diagram showing an example of the functional arrangement of an acoustic diagnostic apparatus 2 according to the second embodiment. In FIG. 23, the same reference numerals as in FIG. 1 denote the same members and a detailed description thereof will be omitted. Different portions will mainly be described below. That is, portions not mentioned below are the same as in the first embodiment.

The acoustic diagnostic apparatus 2 according to the second embodiment is different from the acoustic diagnostic apparatus 1 according to the first embodiment in that a first microphone 21 and a second microphone 22 of a sound receiving unit 20 are arrangement differently, a diagnostic processing unit 30A is provided instead of the diagnostic processing unit 30, and a positioning mechanism 70 is provided instead of the positioning mechanism 60.

The diagnostic processing unit 30A includes an intensity evaluation unit 36 in addition to an impulse response calculation unit 31, an intensity calculation unit 32, a sound absorption coefficient calculation unit 33, a sound absorption coefficient change evaluation unit 34, and an acoustic vibration signal generation unit 35.

The intensity evaluation unit 36 diagnoses a diagnosis target object 90 by evaluating an acoustic characteristic based on a change in intensity.

(Arrangement of Microphones 21 and 22)

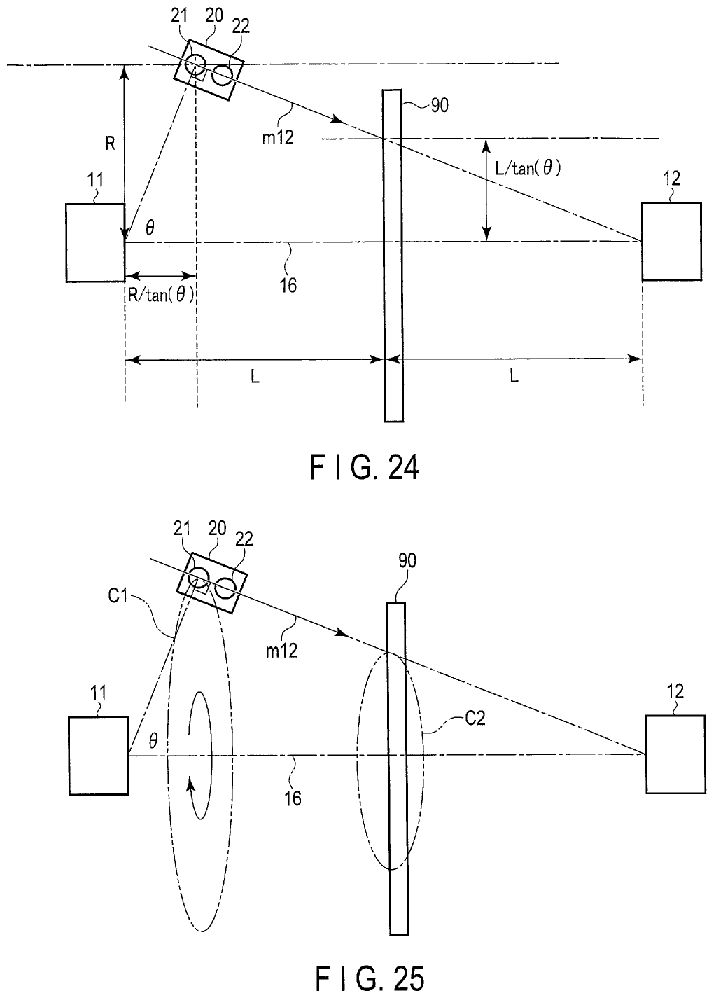

The arrangement of the first microphone 21 and the second microphone 22 will be described next with reference to FIG. 24. FIG. 24 is a view showing the arrangement of the first microphone 21 and the second microphone 22 of the acoustic diagnostic apparatus 2 according to the second embodiment.

In this embodiment, the positioning mechanism 70 arranges the sound receiving unit 20 so that a measurement axis m12 passing through the first microphone 21 and the second microphone 22 passes through the sound source center of a mirror image sound source 12, the positive direction of the measurement axis m12 faces the mirror image sound source 12, and the measurement axis m12 is orthogonal to a line segment connecting the first microphone 21 and the sound source center of a speaker 11. Furthermore, the positioning mechanism 70 holds the sound receiving unit 20 to be rotatable about a speaker axis 16.

Referring to FIG. 24, the intensity measurement axis m12 is orthogonal to the line segment connecting the microphone 21 and the sound source center of the speaker 11. Therefore, the flow of energy from the speaker 11 is not reflected on the measured intensity on the measurement axis m12 in principle, and the flow of energy only from the mirror image sound source 12 is acquired. That is, the intensity on the measurement axis m12 is given by:

$$I ( ω ) = \frac{- 1}{ω ρ d} Im [ {X}_{21}^{*} ( ω ) {X}_{22} ( ω ) ] {\vert {q}_{2} ( ω ) \vert}^{2} \qquad ( 33 )$$

Since the intensity is a directional vector quantity, it is possible to reduce the influence of ambient reflection. Furthermore, since this measured intensity represents energy from the mirror image sound source 12, it is possible to evaluate deterioration of the diagnosis target object 90 by monitoring a characteristic change.

Note that if, among TSP signals, a signal called a Logss signal is used as an acoustic vibration signal, a distortion characteristic as a nonlinear characteristic can be separated and acquired. In addition to evaluation of the intensity of the linear characteristic, the intensity of the separated and extracted distortion characteristic may be evaluated and determination of deterioration may be performed. Note that the distortion characteristic generated in an acoustic vibration of the diagnosis target object 90 is a nonlinear characteristic represented by a “chatter vibration” of the diagnosis target object 90, and is useful for determining deterioration of the support member.

(Focus Range)

The practical installation positions of the microphones 21 and 22 and the focus range of the diagnosis target object 90 will be explained below.

When L represents the distance between the speaker 11 and the diagnosis target object 90 and 0 represents a measurement angle concerning a focus, the installation coordinates of the microphone 21 are given by:

$$( R / tan ( θ ) , R ) \\ R = \frac{2 L}{tan ( θ ) + \frac{1}{tan ( θ )}} \qquad ( 34 )$$

The microphone 22 is installed on the measurement axis at a distance d from the microphone 21. With respect to the x coordinate of the microphone 21, expression (35) below holds.

R/tan(θ)<L (35)

Thus, θ is set within a range satisfying expression (36) below, that is, a range satisfying expression (37) below. That is, θ is set within a range of 45°<θ<90°.

$$\frac{2}{{tan}^{2} ( θ ) + 1} < 1 \qquad ( 36 )$$

$${cos}^{2} ( θ ) < 1 / 2 \qquad ( 37 )$$

In this case, the distance between the speaker axis 16 and the intersection point of the measurement axis m12 and the diagnosis target object 90 is given by:

L/tan(θ) (38)

A measurement focus is obtained at this distance. That is, as L is decreased or θ is increased, a region of interest to the diagnosis target object 90 is decreased, thereby increasing the measurement resolution. Conversely, as L is increased or θ is decreased, the region of interest to the diagnosis target object 90 is increased, thereby increasing the traverse measurement speed.

(Region of Interest)

The region of interest to the diagnosis target object 90 will be described next with reference to FIG. 25. FIG. 25 is a view schematically showing the region of interest to the diagnosis target object 90.

The region of interest is a region in a circumference C1 obtained by rotating the two microphones 21 and 22 about the speaker axis 16. A region in a circumference C2 formed on the plane 91 of the diagnosis target object 90 when the intersection point of the plane 91 of the diagnosis target object 90 and the measurement axis m12 rotates is a focus region. Intensity values are measured at some measurement points on the circumference C1, and the average value of the intensity values is set as a measured intensity value. The number of the measurement points is at least three, that is, the measurement point is set at least every 120°. By measuring intensity values at a plurality of measurement points, as described above, the average reflectance in the region of interest can be measured. Furthermore, with the averaging processing, the influence of ambient reflection can be reduced more than one intensity measurement operation.

(Diagnostic Method)

A diagnostic method executed by the intensity evaluation unit 36 will be described next. Three diagnostic methods will now be described.

The first diagnostic method is a method generally used in deterioration diagnosis, in which comparison with a baseline is performed. In this method, intensity measurement is performed in advance at the time of occurrence of a failure mode (deterioration of a joining force, a welding defect, cracking, or hollowing), and the intensity baseline of the allowable range is measured. The measured intensity value in the direction of the mirror image sound source 12 is compared with the intensity baseline, and it is determined whether transition is performed to a dangerous line. If, for example, the measured intensity value in the direction of the mirror image sound source 12 exceeds the intensity baseline, an abnormal state is determined. By setting the frequency as the abscissa and plotting the measured intensity value and the intensity baseline, determination of deterioration is performed.

The second diagnostic method is deterioration progress diagnosis by a change over time, and determines an abnormal state by determining, by monitoring a time-series change, whether the measured intensity value tends to increase or decrease. By setting the frequency as the abscissa and plotting the measured intensity value in the direction of the mirror image sound source 12, the change tendency of the intensity value over time is grasped.

The third diagnostic method is diagnosis of peeling of a damping material adhered to the diagnosis target object 90, and is a determination method using the fact that the diagnosis target object 90 such as a plate material (surface material) obtains the sound absorption characteristic by vibrating. In general, if the damping material peels off, the plate material vibrates, the sound absorption characteristic increases, and thus the active intensity value such that the positive direction of the measurement axis faces the diagnosis target object 90 increases. By grasping the increasing tendency of the intensity value based on the measured intensity value in the direction of the mirror image sound source 12, peeling of the damping material is determined.

(Sound Absorption Coefficient Measurement)

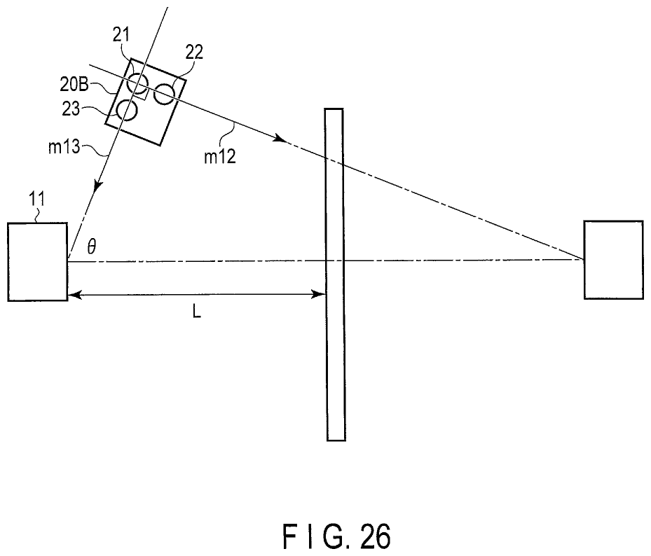

A modification of the sound receiving unit 20 and sound absorption coefficient measurement will be described next with reference to FIG. 26. FIG. 26 is a view showing a modification of the sound receiving unit 20, that is, a sound receiving unit 20B.

The sound receiving unit 20B includes a third microphone 23 in addition to the first microphone 21 and the second microphone 22. As described above, the intensity measurement axis m12 passing through the first microphone 21 and the second microphone 22 faces the sound source center of the mirror image sound source 12.

The third microphone 23 is arranged on a line segment connecting the first microphone 21 and the sound source center of the speaker 11. The third microphone 23 is closer to the speaker 11, as compared with the first microphone 21, and is arranged at the distance d from the first microphone 21. Intensity on a measurement axis m13 passing through the first microphone 21 and the third microphone 23 will be examined. The measurement axis m13 faces the sound source center of the speaker 11.

Since the measurement axis m13 passing through the first microphone 21 and the third microphone 23 is orthogonal to a line segment connecting the first microphone 21 and the sound source center of the mirror image sound source 12, the flow of energy from the mirror image sound source 12 is not reflected on the measured intensity on the measurement axis m13 in principle, and the flow of energy only from the speaker 11 is acquired. That is, intensity I₁₃ in the direction of the speaker 11, that is, the intensity I₁₃ on the measurement axis m13 is given by:

$${I}_{13} ( ω ) = \frac{- 1}{ω ρ d} Im [ {X}_{11}^{*} ( ω ) {X}_{13} ( ω ) ] {\vert {q}_{1} ( ω ) \vert}^{2} \qquad ( 39 )$$

Note that intensity I₁₂ in the direction of the mirror image sound source 12, that is, the intensity I₁₂ on the measurement axis m12 is given by:

$${I}_{12} ( ω ) = \frac{- 1}{ω ρ d} Im [ {X}_{21}^{*} ( ω ) {X}_{22} ( ω ) ] {\vert {q}_{2} ( ω ) \vert}^{2} \qquad ( 40 )$$

Furthermore, equations (41) below hold.

X₂₁*(ω)X₂₂(ω)=e^{jkd}/(16π²(2L sin(θ))(2L sin(θ)−d))

X₁₁*(ω)X₁₃(ω)=e^{jkd}/(16π²(2L cos(θ))(2L cos(θ)−d)) (41)

Thus, the sound absorption coefficient is obtained by:

$$α ( ω ) = 1 - \frac{{\vert {q}_{2} ( ω ) \vert}^{2}}{{\vert {q}_{1} ( ω ) \vert}^{2}} = 1 - \frac{tan ( θ ) ( 2 L sin ( θ ) - d ) ) {I}_{12} ( ω )}{( 2 L cos ( θ ) - d ) {I}_{13} ( ω )} \qquad ( 42 )$$

That is, by rotating the three microphones 21, 22, and 23 about the speaker axis 16, performing measurement at a plurality of measurement points, obtaining the intensity I₁₃ in the direction of the speaker 11 and the intensity I₁₂ in the direction of the mirror image sound source 12 (average values), and using equations (39), (40), and (41), it is possible to measure the sound absorption coefficient. Note that the sound absorption coefficient may be obtained at each measurement point in accordance with equations (39) to (42), and the results of the sound absorption coefficients at the respective measurement points may be averaged, thereby obtaining the sound absorption coefficient.

That is, the diagnostic processing unit 30A performs the following processing for the sound receiving unit 20B. The impulse response calculation unit 31 calculates the impulse response of the third microphone 23 based on the sound reception signal of the third microphone 23. The intensity calculation unit 32 calculates an intensity value on the measurement axis m13 passing through the first microphone 21 and the third microphone based on the impulse responses of the first microphone 21 and the third microphone 23. The sound absorption coefficient calculation unit 33 calculates a sound absorption coefficient using the intensity value on the measurement axis m13. The sound absorption coefficient change evaluation unit 34 diagnoses the diagnosis target object 90 by evaluating the acoustic characteristic based on a change in sound absorption coefficient.

(First Structure Example of Positioning Mechanism 70)

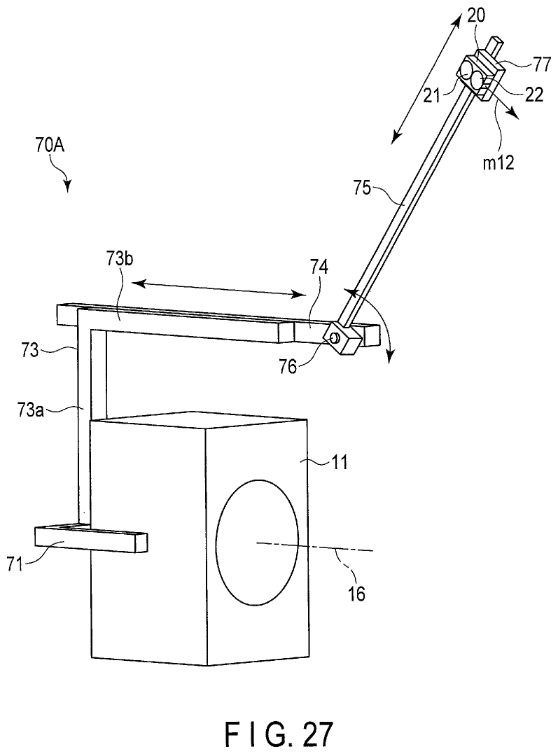

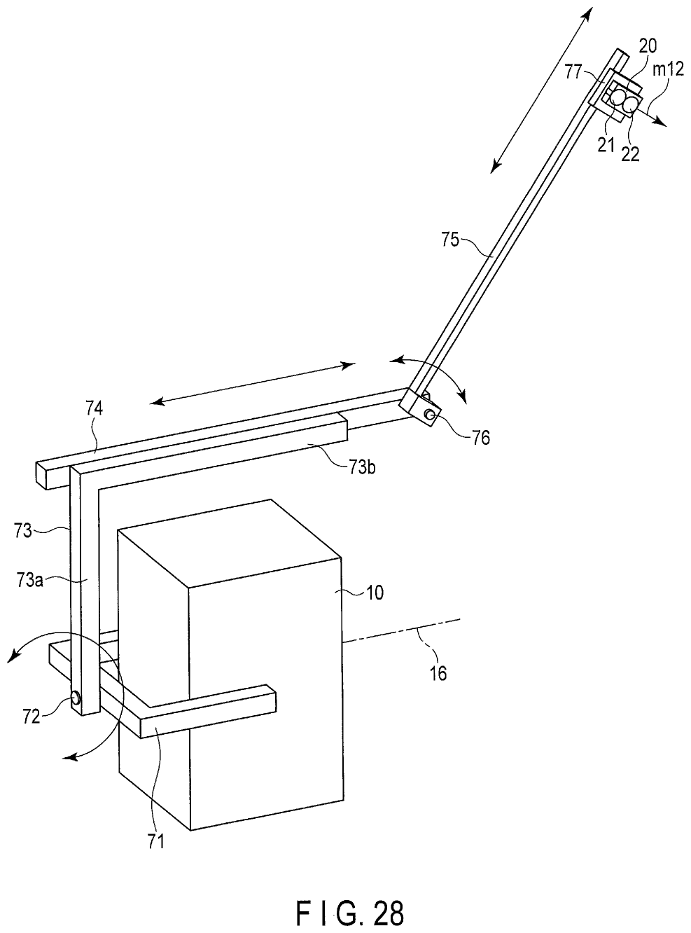

The first structure example of the positioning mechanism 70 will be described next with reference to FIGS. 27 and 28. FIGS. 27 and 28 are perspective views each showing the first structure example of the positioning mechanism 70, that is, a positioning mechanism 70A. FIG. 27 is a perspective view of the positioning mechanism 70A when viewed from the first direction. FIG. 28 is a perspective view of the positioning mechanism 70A when viewed from the second direction different from the first direction.

The positioning mechanism 70A includes a base 71, an arm 73, a slider 74, an arm 75, and a holder 77.

The base 71 is fixed to the speaker 11. The arm 73 has an L shape, and includes a linear first arm portion 73a and a linear second arm portion 73b which are orthogonal to each other. An end portion of the first arm portion 73a is connected to the base 71 to be rotatable via a shaft 72. The center axis of the shaft 72 coincides with the speaker axis 16 of the speaker 11.

The slider 74 is linear, and is connected to the second arm portion 73b of the arm 73 to be linearly movable along the second arm portion 73b. The arm 75 is linear. An end portion of the arm 75 is connected to an end portion of the slider 74 to be rotatable via a shaft 76. The holder 77 is connected to the arm 75 to be linearly movable along the arm 75. The holder 77 holds the sound receiving unit 20 including the microphones 21 and 22 or the microphones 21, 22, and 23 (the microphone 23 is not illustrated).

In this positioning mechanism 70, by moving the slider 74 along the second arm portion 73b of the arm 73, the microphones 21 and 22 can be moved in parallel to the speaker axis 16 of the speaker 11. By turning the arm 75 about the shaft 76, the direction of the measurement axis m12 passing through the first microphone 21 and the second microphone 22 can be changed. Furthermore, by moving the holder 77 along the arm 75, the distance from the speaker axis 16 of the speaker 11 to the microphones 21 and 22 can be changed. This can position the sound receiving unit 20 in the positional relationship shown in FIG. 24.

Furthermore, by turning the arm 73 about the shaft 72, the angle position of the sound receiving unit 20, that is, the microphones 21 and 22 around the speaker axis 16 of the speaker 11 can be changed. This can move the sound receiving unit 20, that is, the microphones 21 and 22 on the circumference C1 having the speaker axis 16 as the center, as shown in FIG. 25. Thus, it is possible to measure intensity values at a plurality of measurement points.

(Second Structure Example of Positioning Mechanism 70)

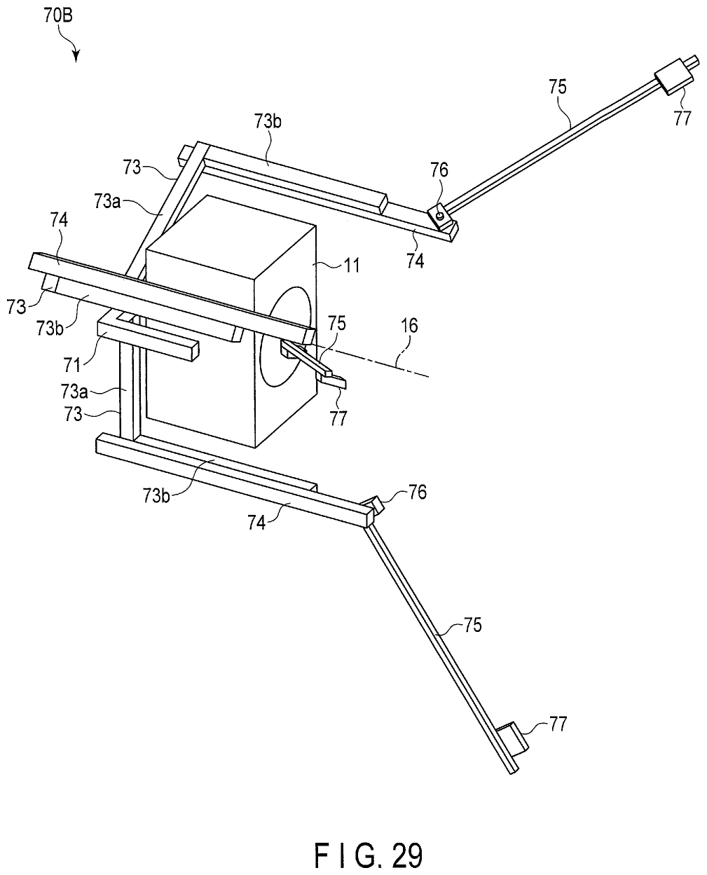

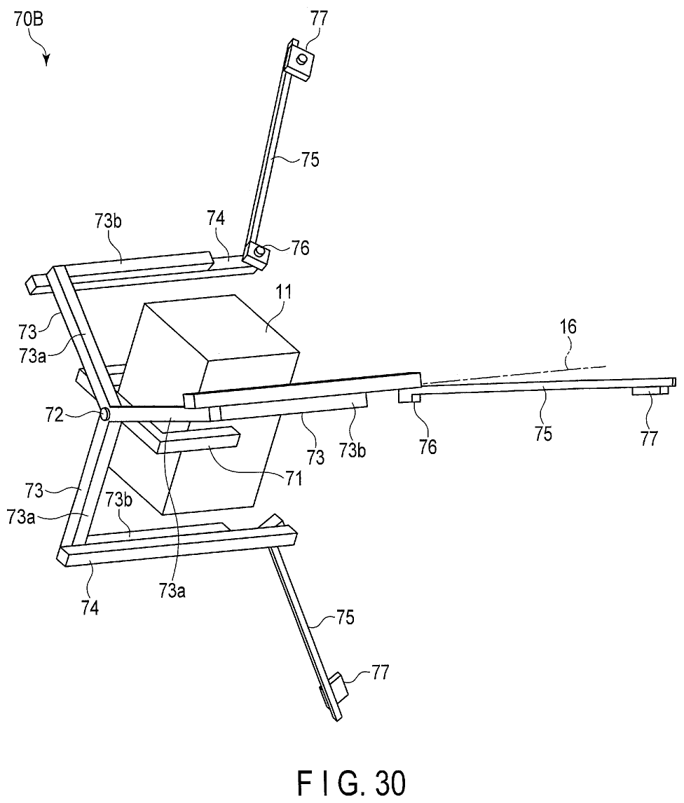

The second structure example of the positioning mechanism 70 will be described next with reference to FIGS. 29 and 30. FIGS. 29 and 30 are perspective views each showing the second structure example of the positioning mechanism 70, that is, a positioning mechanism 70B. FIG. 29 is a perspective view of the positioning mechanism 70B when viewed from the first direction. FIG. 30 is a perspective view of the positioning mechanism 70B when viewed from the second direction different from the first direction. In FIGS. 29 and 30, the same reference numerals as in FIGS. 27 and 28 denote the same members and a detailed description thereof will be omitted.

The positioning mechanism 70B includes three sets each including an arm 73, a slider 74, an arm 75, and a holder 77. The arrangement of the arm 73, the slider 74, the arm 75, and the holder 77 of each set is the same as the first structure example of the positioning mechanism 70, that is, the positioning mechanism 70A.

The three arms 73 are integrated at an interval of 120° around the center of a shaft 72. That is, the integrated three arms 73 are connected to the base 71 to be rotatable about the shaft 72.

In the acoustic diagnostic apparatus 2 using the positioning mechanism 70B, three sound receiving units 20 are arranged on the circumference C1. Therefore, it is possible to measure intensity values at a plurality of measurement points at the same time without rotating the sound receiving units 20.

As is apparent from the above description, instead of analyzing the actual operation sound from the diagnosis target object 90, the acoustic diagnostic apparatus 2 according to this embodiment can apply an acoustic vibration to the diagnosis target object 90, analyze a sound wave emitted from the diagnosis target object 90, acquire acoustic characteristic information of an analysis designation frequency band, and then determine deterioration.

According to the above embodiments, there can be provided an acoustic diagnostic apparatus that diagnoses, in a contactless manner, a diagnosis target object by applying an acoustic vibration to the diagnosis target object.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. An acoustic diagnostic apparatus comprising:
a speaker configured to emit a sound wave for an acoustic vibration to a diagnosis target object;
a sound receiving unit including a first microphone and a second microphone each configured to receive a sound wave from the diagnosis target object;
a positioning mechanism configured to position the sound receiving unit;
an impulse response calculation unit configured to calculate impulse responses of the first microphone and the second microphone based on sound reception signals of the first microphone and the second microphone, respectively;
an intensity calculation unit configured to calculate, based on the impulse responses of the first microphone and the second microphone, a first intensity value on a measurement axis passing through the first microphone and the second microphone;
a sound absorption coefficient calculation unit configured to calculate a first sound absorption coefficient from the first intensity value; and
a sound absorption coefficient change evaluation unit configured to diagnose the diagnosis target object by evaluating an acoustic characteristic based on a change in the first sound absorption coefficient.

2. The acoustic diagnostic apparatus according to claim 1, wherein the positioning mechanism arranges the first microphone and the second microphone on a speaker axis extending in an emission direction of the sound wave, and holds the sound receiving unit to be movable along the speaker axis.

3. The acoustic diagnostic apparatus according to claim 2, wherein the sound absorption coefficient calculation unit calculates the sound absorption coefficient using the intensity values at a plurality of measurement points at each of which the sound receiving unit is arranged by the positioning mechanism.

4. The acoustic diagnostic apparatus according to claim 3, wherein if the sound absorption coefficient increases, the sound absorption coefficient change evaluation unit diagnoses peeling of a damping material adhered to the diagnosis target object.

5. The acoustic diagnostic apparatus according to claim 3, wherein the sound absorption coefficient change evaluation unit compares the first sound absorption coefficient with a sound absorption coefficient baseline of a deterioration state defined by performing measurement in advance at the time of occurrence of a failure mode, and diagnoses deterioration of the diagnosis target object.

6. The acoustic diagnostic apparatus according to claim 1, wherein the positioning mechanism arranges the sound receiving unit so that the measurement axis passing through the first microphone and the second microphone passes a sound source center of a mirror image sound source located plane-symmetrically with the speaker with respect to a plane of the diagnosis target object facing the speaker and is orthogonal to a line segment connecting the first microphone and a sound source center of the speaker, and holds the sound receiving unit to be rotatable about a speaker axis of the speaker.

7. The acoustic diagnostic apparatus according to claim 6, further comprising an intensity evaluation unit configured to diagnose deterioration of the diagnosis target object by evaluating a change in the first intensity value.

8. The acoustic diagnostic apparatus according to claim 7, wherein a positive direction of the measurement axis faces the mirror image sound source, and the intensity evaluation unit diagnoses, if the first intensity value increases, peeling of a damping material adhered to the diagnosis target object.

9. The acoustic diagnostic apparatus according to claim 6, wherein
the sound receiving unit further includes a third microphone configured to receive the sound wave from the speaker, and the third microphone is arranged on a line segment connecting the first microphone and the sound source center of the speaker,
the impulse response calculation unit calculates an impulse response of the third microphone based on a sound reception signal of the third microphone,
the intensity calculation unit calculates, based on the impulse responses of the first microphone and the third microphone, a second intensity value on a measurement axis passing through the first microphone and the third microphone,
the sound absorption coefficient calculation unit calculates a second sound absorption coefficient using the second intensity value, and
the sound absorption coefficient change evaluation unit diagnoses the diagnosis target object by evaluating an acoustic characteristic based on a change in the second sound absorption coefficient.

10. The acoustic diagnostic apparatus according to claim 9, wherein if the sound absorption coefficient increases, the sound absorption coefficient change evaluation unit diagnoses peeling of a damping material adhered to the diagnosis target object.

11. The acoustic diagnostic apparatus according to claim 9, wherein the sound absorption coefficient change evaluation unit compares the first sound absorption coefficient with a sound absorption coefficient baseline of a deterioration state defined by performing measurement in advance at the time of occurrence of a failure mode, and diagnoses deterioration of the diagnosis target object.

12. An acoustic diagnostic method comprising:
causing a speaker to emit a sound wave for an acoustic vibration to a diagnosis target object by continuously inputting an acoustic vibration signal;
calculating, based on sound reception signals output from a first microphone and a second microphone sequentially positioned at a plurality of measurement points and each configured to receive a sound wave from the diagnosis target object, impulse responses of the first microphone and the second microphone, respectively;
calculating, based on the impulse responses of the first microphone and the second microphone, a first intensity value on a measurement axis passing through the first microphone and the second microphone;
calculating a sound absorption coefficient from the first intensity value; and
diagnosing the diagnosis target object by evaluating an acoustic characteristic based on a change in the sound absorption coefficient.

13. A non-transitory computer-readable storage medium storing an acoustic diagnostic program for causing a computer, including a processor and a storage device, to
execute functions of an impulse response calculation unit, an intensity calculation unit, a sound absorption coefficient calculation unit, and a sound absorption coefficient change evaluation unit, all of which are defined in claim 1.
